(19) United States
(12) Patent Application Publication
(10) Pub. No.: US 2008/0070791 A1
(43) Pub. Date: Mar. 20, 2008

(54) Libraries Of Chimeric Cellulose Binding Proteins And Methods Of Use Thereof

(75) Inventor: Ely Morag, Misgav Dov (IL)

Correspondence Address: BROWDY AND NEIMARK, P.L.L.C.;624 NINTH STREET, NW, SUITE 300, WASHINGTON, DC, 20001-5303, US

(73) Assignee: ZEPHYR PROTEOMIX LTD., Kiryat Shmona (IL)

(21) Appl. No.: 10/571,394

(22) PCT Filed: Sep. 9, 2004
(86) PCT No.: PCT/IL04/00817

§ 371 Date: Mar. 22, 2007

Related U.S. Application Data
(60) Provisional application No. 60/501,093, filed on Sep. 9, 2003.

(51) Int. Cl. C40B 40/10; C40B 30/04; C40B 40/08

(52) U.S. Cl. 506/9; 506/17; 506/18

(57) ABSTRACT

The present invention relates to libraries of chimeric proteins and libraries of polynucleotides encoding same, wherein each chimeric protein comprises a cellulose-binding region and at least one exogenous moiety, the exogenous moiety preferably comprising at least one peptide. The present invention further relates to use of the libraries for screening assays. Methods of high throughput screening using these libraries for biological active moieties such as enzymes and antibodies are also included within the scope of the present invention.

### FIELD OF THE INVENTION

The present invention relates to libraries of chimeric proteins and libraries of polynucleotides encoding same, wherein each chimeric protein comprises a cellulose-binding region and at least one exogenous moiety, the exogenous moiety preferably comprising at least one peptide. The present invention further relates to use of the libraries for screening assays. Methods of high throughput screening using these libraries for biological active moieties such as enzymes and antibodies are also included within the scope of the present invention.

### BACKGROUND OF THE INVENTION

Potent cellulolytic bacteria and fungi produce a battery of cellulases, which act synergistically to solubilize crystalline cellulose. Cellulolytic systems can be either associated in multienzyme complexes called cellulosomes, or unassociated, as individual enzymes that possess both catalytic and cellulose binding properties (Carrard et al., Proc. Natl. Acad. Sci. 97:10342-7, 2000). The unassociated enzymes consist generally of two joined domains, the catalytic domain responsible for the hydrolysis reaction and of a cellulose binding domain (CBD) mediating binding of the enzymes to the substrate. The multienzyme cellulosome complex contains separate enzymes bound noncovalently to the non-catalytic cellulosome-intergrating protein, also termed Cip, which comprises a CBD. The cellulosome-intergrating protein Cip is devoid of enzymatic activity, particularly, it is devoid of a cellulolytic activity.

Fusion proteins comprising cellulose binding domains derived from cellulolytic enzymes and their applications for protein isolation are known in the art. U.S. Pat. No. 5,137,819 discloses an improved method for immobilization of a polypeptide of interest, using an affinity matrix which comprises: preparing a fusion protein comprising the polypeptide of interest and an amino acid sequence derived from a cellulose binding region of a cellulase essentially lacking in cellulase activity; and contacting said fusion protein with an affinity matrix comprising a cellulose substrate for said cellulase whereby said substrate binding region binds to said affinity matrix.

Other methods for protein immobilization and purification involving use of fusion protein or protein conjugates comprising the substrate binding region of a polysaccharidase are disclosed in U.S. Pat. Nos. 5,202,247; 5,340,731; 5,962,289 and in U.S. Pat. Nos. 5,928,917, respectively.

U.S. Pat. No. 5,496,934 discloses a polynucleotide encoding a cellulose binding domain derived from Clostridium Cellulovorans. Proteins and fusion proteins comprising the CBD of Clostridium Cellulovorans, methods of purification thereof and complexes containing same, kits and methods of detection based on said proteins among other applications, are disclosed in divisional patents and in a CIP patent of U.S. Pat. No. 5,496,934, i.e. U.S. Pat. No. 5,670,623; U.S. Pat. No. 5,719,044; U.S. Pat. No. 5,738,984; 5,837,814 and U.S. Pat. No. 5,856,201, respectively.

U.S. Pat. No. 6,407,208 discloses a chimeric protein comprising a cellulose-binding domain generated from cellulobiohydrolase-I of Trichoderma konigii G39, which has a C-terminal site, joined to a peptide containing arginine-glutamate-aspartate and an N-terminal joined to a thioredoxin.

International Patent Application No. WO96/13524 to the applicants of the present invention and coworkers, discloses a modified cellulose binding domain (CBD), particularly a biotinylated CBD having a binding affinity to cellulose similar to the binding affinity of an unmodified CBD. The invention relates to a process for over expression of the soluble form of CBD of the scaffoldin subunit from the cellulosome of Clostridium thermocellum in suitable host cells.

International Patent Application No. WO03/074722 to the applicants of the present invention discloses microarrays comprising a plurality of chimeric proteins immobilized onto a solid substrate, each immobilized protein comprises a cellulose binding region bound to one or more exogenous moieties, wherein the one or more exogenous moieties are exposed to the external environment in an accessible orientation.

A gene that encodes a cellulose binding region derived from a non-cellulolytic cellulosomal scaffolding Protein A, also termed hereinafter CipB, of clostridium thermocellum was isolated from a gene library of C. thermocellum strain YS by the inventor of the present invention and co-workers (Poole et al., FEMS Microbiol Lett. 1992, 78:181-6; SEQ ID NOS:1-3). The inventor of the present invention and co-workers further cloned and overexpressed a major cellulose-binding domain (CBD) from the cellulosome of Clostridium thermocellum (Morag et al., Appl. Environ. Microbiol. 1995, 61:1980-6; SEQ ID NOS:4-6).

There is an unmet need for libraries and assays that provide an efficient, simple, low-cost and particularly a rapid tool for high throughput analyses. Nowhere in the background art is it taught or suggested that chimeric proteins comprising a cellulose-binding region bound to an exogenous moiety may be used for high throughput methods, particularly high throughput screening, wherein the screening step is carried out while the chimeric proteins are mobile and thus provide an improved access of the screened moieties to the screening molecule.

### SUMMARY OF THE INVENTION

The present invention relates to libraries comprising a plurality of chimeric proteins and to corresponding libraries of polynucleotides encoding same, each chimeric protein comprising a cellulose binding region, wherein the cellulose binding region is essentially devoid of cellulolytic activity. Particularly, each chimeric protein comprising a cellulose binding region and at least one exogenous biologically active moiety. The present invention further relates to kits encompassing the libraries and methods for generating said libraries.

The present invention also relates to methods for using libraries comprising a plurality of chimeric proteins. Particularly, the present invention provides assays for high throughput screening, wherein the initial step of each assay includes screening the library of the chimeric proteins for a desired activity or function, including but not limited to, the ability to specifically bind to an antibody, a receptor or other molecules. The screened library is then immobilized onto a solid substrate that is capable of binding to the cellulose binding region and finally identification of the at least one exogenous biologically active moiety having the desired activity or function is carried out.

The screening procedure is advantageously carried out prior to immobilizing the products onto a solid support thus rendering the assays of the invention suitable for detection and screening of any kind of biological moieties. The present invention therefore eliminates limitations on either the biological active moieties within the chimeric moieties or the types of sample that may be screened, including biological moieties that may not be accessible to the external environment upon immobilization of the chimeric protein to a solid substrate.

Another advantage of the libraries and assays of the present invention over known methods is simplicity of immobilization after the screening step has been accomplished. In most embodiments of the present invention, the solid substrate for immobilization comprises cellulose polymers that readily bind to chimeric proteins comprising a cellulose binding region. The low cost of cellulose polymers is another advantage of the assays of the present invention.

In addition, the chimeric proteins of the present invention, even bound to a new moiety as the result of the screening step, need not be chemically modified or substantially purified prior to immobilization onto the solid support.

Yet another advantage of the libraries and assays of the present invention is an outstanding stability of the substrate comprising the chimeric proteins at the detection step, even under harsh and extreme conditions, such as high temperature and high detergents concentrations among others.

Another advantage is the low background generated by the cellulose polymer and the relatively high signal generated by the chimeric proteins bound thereto, at the detection step.

The libraries, kits, methods and assays of the present invention are suitable for use with many of the cellulose binding regions, cellulose matrices and fabrication technologies known in the art. Preferably, the cellulose binding region used in the compositions and methods of the present invention are derived from a protein that is essentially devoid of enzymatic activity, particularly devoid of a cellulolytic activity. According to certain embodiments, the chimeric proteins of the present invention comprise cellulose binding regions derived from the non-cellulolytic cellulosomal scaffolding Protein A, also termed hereinafter CipB, of clostridium thermocellum (Poole et al., FEMS Microbiol Lett. 1992, 78:181-6; SEQ ID NOS:1-3). This cellulose binding region has proven particularly effective and have yielded unexpectedly advantageous exemplary results.

These and other advantages of the libraries and assays of the present invention appoint them as an ideal platform for applications which require a large workload at high speed, high sensitivity and low cost.

According to a first aspect, the present invention provides a library comprising a plurality of chimeric proteins wherein each chimeric protein comprises a cellulose binding region and at least one exogenous moiety introduced therein, and wherein the cellulose binding region is devoid of cellulolytic activity.

According to another embodiment, the cellulose binding region is derived from a protein other than a member of the polysaccharidase family. Preferably, the cellulose binding region is derived from the non-cellulolytic cellulosomal scaffolding Protein A subunit of Clostridium thermocellum.

According to an alternative embodiment, the cellulose binding region comprising an amino acid sequence having at least 80% homology, preferably at least 90% homology, to SEQ ID NO:4, wherein the cellulose binding region may further comprise at least one additional amino acid sequence having at least 80% homology, preferably at least 90% homology, to any one of the sequences selected from the group consisting of: SEQ ID NO:5 and SEQ ID NO:6.

According to another alternative embodiment, the cellulose binding region is encoded by a polynucleotide sequence comprising a nucleotide sequence having at least 80% homology, preferably at least 90% homology to SEQ ID NO:1, wherein the polynucleotide sequence may further comprise at least one additional polynucleotide sequence having at least 80% homology, preferably having at least 90% homology to the any one of the nucleotide sequences selected from the group consisting of: SEQ ID NO:2 and SEQ ID NO:3.

It is to be understood explicitly that the scope of the present invention encompasses homologs, analogs, variants and derivatives, including shorter and longer polypeptides, proteins and polynucleotides, as well as polypeptide, protein and polynucleotide analogs with one or more amino acid or nucleic acid substitution, as well as amino acid or nucleic acid derivatives, non-natural amino or nucleic acids and synthetic amino or nucleic acids as are known in the art, with the stipulation that these variants and modifications must preserve the capacity of binding cellulose of the original molecule in the context of the libraries, kits and methods of the present invention. Specifically, any active fragments of the active polypeptide or protein as well as extensions, conjugates and mixtures are disclosed according to the principles of the present invention.

According to another embodiment, wherein the at least one exogenous moiety introduced therein is biologically active. According to yet another embodiment, the at least one biologically active moiety is selected from the group consisting of: peptides, polypeptides, including enzymes, antibodies and fragments thereof, antigenic epitopes, polynucleotides, hormones, carbohydrates, lipids, phospholipids and biotinylated probes.

According to a preferred embodiment, the biologically active moiety is a peptide. According to some embodiments, the peptide comprises a sequence of 5 to 50 amino acids.

According to another embodiment, the at least one exogenous biologically active moiety is introduced into the cellulose binding region at a predetermined location other than the C-terminus or the N-terminus of said cellulose binding region.

According to yet another embodiment, the at least one exogenous biologically active moiety is fused to the cellulose binding region at the C-terminus or the N-terminus of said cellulose binding region.

According to yet another embodiment, the at least one exogenous biologically active moiety is covalently linked to the cellulose binding region.

According to yet another embodiment, each chimeric protein comprises a detectable label, wherein the amount of the detectable label is indicative of the amount of chimeric protein.

According to another aspect, the present invention provides a library comprising a plurality of polynucleotides, each polynucleotide is capable of encoding a chimeric protein comprising a cellulose binding region and at least one exogenous moiety introduced therein, and wherein the cellulose binding region is devoid of cellulolytic activity.

According to another embodiment, the cellulose binding region is derived from a protein other than a member of the polysaccharidase family. Preferably, the cellulose binding region is derived from the non-cellulolytic cellulosomal scaffolding Protein A subunit of Clostridium thermocellum.

According to an alternative embodiment, the polynucleotide comprising a first nucleotide sequence capable of encoding the cellulose binding region having at least 80% homology, preferably at least 90% homology, to SEQ ID NO:4. According to one embodiment, the first nucleotide sequence further encodes at least one additional amino acid sequence having at least 80% homology, preferably at least 90% homology, to any one of the sequences selected from the group consisting of: SEQ ID NO:5 and SEQ ID NO:6.

According to another alternative embodiment, the polynucleotide comprising a first nucleotide sequence having at least 80% homology, preferably at least 90% homology to SEQ ID NO:1. According to one embodiment, the first nucleotide sequence further comprises at least one additional nucleotide sequence having at least 80% homology, preferably having at least 90% homology to the any one of the nucleotide sequences selected from the group consisting of: SEQ ID NO:2 and SEQ ID NO:3.

According to another embodiment, the polynucleotide further comprising a second nucleotide sequence encoding at least one exogenous biologically active moiety, the second nucleotide sequence is operably linked to the first nucleotide sequence such that the polynucleotide encodes a chimeric protein comprising at least one exogenous biologically active moiety fused to the cellulose binding region at the C-terminus or the N-terminus of said cellulose binding region.

According to an alternative embodiment, the second nucleotide sequence is operably linked to the first nucleotide sequence such that the polynucleotide encodes a chimeric protein comprising at least one exogenous biologically active moiety introduced into the cellulose binding region at a predetermined location other than the C-terminus or the N-terminus of said cellulose binding region.

According to yet another embodiment, the at least one biologically active moiety is selected from the group consisting of:, peptides and polypeptides, including enzymes, antibodies and fragments thereof.

According to a preferred embodiment, the at least one biologically active moiety is a peptide. According to some embodiments, the peptide comprises a sequence of 5 to 50 amino acids.

According to yet another aspect, the present invention provides a method for screening biologically active moieties, comprising:
(a) providing a plurality of discrete compartments, each compartment comprising a chimeric protein, the chimeric protein comprising a cellulose binding region devoid of cellulolytic activity and at least one exogenous biologically active moiety; and
(b) bringing into contact one or more aliquots of a sample with the content of each discrete compartment thereby bringing into contact said chimeric protein in each discrete compartment with the sample;
(c) printing one or more aliquots of the content of each discrete compartment onto at least one discrete location on a surface of a solid support, the surface comprising a cellulose polymer, thereby immobilizing the chimeric proteins within each discrete compartment onto said surface; and,
(d) detecting binding interactions between said sample and said chimeric protein.

According to one embodiment, the at least one exogenous biologically active moiety is selected from the group consisting of: peptides, polypeptides, including enzymes, antibodies and fragments thereof, antigenic epitopes, polynucleotides, hormones, carbohydrates, lipids, phospholipids and biotinylated probes.

According to a preferred embodiment, the biologically active moiety is a peptide. According to some embodiments, the peptide comprises a sequence of 5 to 50 amino acids.

According to another embodiment, the at least one biologically active moiety is an exogenous peptide, the exogenous peptide is introduced into the cellulose binding region at a predetermined location other than the C-terminus or the N-terminus of said cellulose binding region.

According to yet another embodiment, the at least one biologically active moiety is an exogenous peptide, the exogenous peptide is fused to the cellulose binding region at the C-terminus or the N-terminus of said cellulose binding region.

According to yet another embodiment, at least one biologically active moiety is covalently linked to the cellulose binding region.

According to yet another embodiment, the cellulose binding region is derived from a protein other than a member of the polysaccharidase family. According to yet another embodiment, the cellulose binding region is derived from the non-cellulolytic cellulosomal scaffolding Protein A subunit of Clostridium thermocellum.

According to an alternative embodiment, the cellulose binding region comprising an amino acid sequence having at least 80% homology, preferably at least 90% homology, to SEQ ID NO:4, wherein the cellulose binding region may further comprise at least one additional amino acid sequence having at least 80% homology, preferably at least 90% homology, to any one of the sequences selected from the group consisting of: SEQ ID NO:5 and SEQ ID NO:6.

According to another alternative embodiment, the cellulose binding region is encoded by a polynucleotide sequence comprising a nucleotide sequence having at least 80% homology, preferably at least 90% homology to SEQ ID NO:1, wherein the polynucleotide sequence may further comprise at least one additional polynucleotide sequence having at least 80% homology, preferably having at least 90% homology to the any one of the nucleotide sequences selected from the group consisting of: SEQ ID NO:2 and SEQ ID NO:3.

According to yet another embodiment, each chimeric protein comprising a detectable label, wherein the amount of the detectable label is indicative of the amount of chimeric protein.

According to yet another embodiment, each chimeric protein comprises at least two biologically active moieties, wherein the at least two biologically active moieties are the same or different from one another.

According to yet another embodiment, step (b) comprising: incubating one or more aliquots of a sample with the content of each discrete compartment for at least 5 minutes, thereby bringing into contact said chimeric protein in each discrete compartment with the sample.

According to yet another embodiment, the sample is provided in a solution. According to yet another embodiment the sample is provided in a non-immobilized dry form and is suspended to obtain a corresponding sample solution prior to, or during, step (b) of the method. According to an alternative embodiment, the sample is provided in a form selected from: an immobilized form or present on a solid structure, such as cell membranes or fragments thereof. Accordingly, prior to step (c), the content of each discrete compartment together with said sample, obtained in step (b) are treated to remove unbound chimeric protein and further to release from immobilization bound chimeric proteins.

According to yet another embodiment, the chimeric proteins are provided in a dry form. According to yet another embodiment, the chimeric proteins are suspended to obtain a corresponding solution prior to, or during, step (b) of the method.

According to yet another aspect, the present invention provides a kit comprising:
(a) a plurality of discrete compartments, each compartment comprising a chimeric protein, the chimeric protein comprising a cellulose binding region devoid of cellulolytic activity and at least one exogenous biologically active moiety; and, optionally,
(b) a solid support having a surface, the surface comprising a substrate capable of binding the cellulose binding region.

According to one embodiment, the cellulose binding region is derived from a protein other than a member of the polysaccharidase family. According to another embodiment, the cellulose binding region is derived from the non-cellulolytic cellulosomal scaffolding Protein A subunit of Clostridium thermocellum.

According to an alternative embodiment, the cellulose binding region comprising an amino acid sequence having at least 80% homology, preferably at least 90% homology, to SEQ ID NO:4, wherein the cellulose binding region may further comprise at least one additional amino acid sequence having at least 80% homology, preferably at least 90% homology, to any one of the sequences selected from the group consisting of: SEQ ID NO:5 and SEQ ID NO:6.

According to another alternative embodiment, the cellulose binding region is encoded by a polynucleotide sequence comprising a nucleotide sequence having at least 80% homology, preferably at least 90% homology to SEQ ID NO:1, wherein the polynucleotide sequence may further comprise at least one additional polynucleotide sequence having at least 80% homology, preferably having at least 90% homology to the any one of the nucleotide sequences selected from the group consisting of: SEQ ID NO:2 and SEQ ID NO:3.

According to yet another embodiment, the at least one biologically active moiety is selected from the group consisting of: peptides, polypeptides, including enzymes, antibodies and fragments thereof, antigenic epitopes, polynucleotides, hormones, carbohydrates, lipids, phospholipids and biotinylated probes.

According to a preferred embodiment, the biologically active moiety is a peptide. According to some embodiments, the peptide comprises a sequence of 5 to 50 amino acids.

According to another embodiment, the at least one exogenous biologically active moiety is introduced into the cellulose binding region at a predetermined location other than the C-terminus or the N-terminus of said cellulose binding region.

According to yet another embodiment, the at least one exogenous biologically active moiety is fused to the cellulose binding region at the C-terminus or the N-terminus of said cellulose binding region.

According to yet another embodiment, the at least one exogenous biologically active moiety is covalently linked to the cellulose binding region.

According to yet another embodiment, the surface of the solid support comprises cellulose polymers selected from the group consisting of: cellulose homopolymers, cellulose heteropolymers, cellulose acetate, microcrystalline cellulose, lignin, starch, xylane. According to yet another embodiment, the solid support comprises a material selected from the group consisting of: glass, ceramics, metal and plastics.

These and other aspects of the present invention will be more fully understood from the drawings, detailed description and examples which follows.

### BRIEF DESCRIPTION OF THE DRAWINGS

The invention will be more fully understood and further advantages will become apparent when reference is made to the following detailed description of the invention and the accompanying drawings in which:

FIG. 1 is the nucleotide sequence of the cellulose binding region (in bold; SEQ ID NO:1) and the flanking N-terminus (SEQ ID NO:2) and C-terminus linkers (SEQ ID NO:3) derived from Clostridium thermocellum and the corresponding amino-acid sequence of a cellulose binding region (SEQ ID NO:4) and the flanking N-terminus (SEQ ID NO:5) and C-terminus linkers (SEQ ID NO:6).

FIG. 2 illustrates the expression vector pET3d comprising SEQ ID NO:1, SEQ ID NO:2 and a variant of SEQ ID NO:3 comprising at the C-terminus a fragment of the nucleotide sequence encoding HIV antigen gp41 (A) and the amino-acid and nucleotide sequences of a fragment containing the mutated C-terminus linker (SEQ ID NO:3) comprising a fragment of the nucleotide sequence encoding gp41 (B).

FIG. 3 shows ZEPHYRIN41 expression in total cell extract of BL1 (DE3) cells transfected with pET3d vector (lane 1) and in purified aliquots of the extracts (lanes 2-4).

FIG. 4 presents serum levels of HIV in infected and healthy individuals using recombinant gp41 and ZEPHYRIN41.

FIG. 5 demonstrates a modification of SEQ ID NO:4 at loop 5/6 (A), the expression of a protein comprising this modification in induced BL21 cells (DE3; B) and molecular models of this proteins (C).

FIG. 6 shows the signal-to-noise ratio generated during the screening of various hybridoma using the libraries and assays of the present invention.

FIG. 7 exhibits fluorescence images reflecting levels of antibodies against HIV type 1 and type 2 antigens in sera of infected individuals using microarrays comprising immobilized ZEPHYRIN36, ZEPHYRIN41 and ZEPHYRIN120 as compared to a control microarray (PBS).

FIG. 8 is an image of a microarray comprising a immobilized proteins, each protein comprising a cellulose binding region as set forth in SEQ ID NO:4, labeled with Cy3 (A), biotinylated and detected by Streptavidin ALEXA FLOUR® 546 (Molecular Probes Europe BV, The Netherlands) (B), and labeled at the C-terminus linker with Cy5 labeled rabbit antibody directed against the protein (C), and fabricated on cellulose coated glass slide.

FIG. 9 is (A): an image of the fluorescence signals generated from the interaction between a microarray containing serial dilutions of non-purified (sonicate; right panel) and purified (left panel) immobilized proteins, each protein comprising a cellulose binding region comprising the amino acid sequence as set forth in SEQ ID NO:4 and Cy5 labeled rabbit antibody directed against said cellulose binding region; and (B): an image of a microarray containing immobilized HiS₆-tag labeled protein comprising the cellulose binding region comprising the amino acid sequence as set forth in SEQ ID NO:4 diluted in PBS and in E. Coli cells extract (sonicate; right panel) and detected by Cy5 labeled rabbit His₆ tag antibodies directed against an immobilized protein comprising the amino acid sequence as set forth in SEQ ID NO:4.

FIG. 10 presents an image of a microarray containing serial dilutions of biotinylated- and immobilized-proteins, each protein comprising a cellulose binding region comprising the amino acid sequence as set forth in SEQ ID NO:4 fabricated on cellulose coated glass slide and detected by Streptavidin ALEXA FLOUR® 546 (A) and the corresponding linear regression analysis (B).

FIG. 11 is an image of a microarray of an immobilized ZEPHYRIN41 brought into contact with sera from HIV type 1 infected individuals following incubation with Cy3 goat anti-human IgG (A) and with Cy5 rabbit (B) directed against the cellulose binding region comprising the amino acid sequence as set forth in SEQ ID NO:4.

FIG. 12 is an image of a microarray of serial dilutions in PBS of an immobilized protein comprising the amino acid sequence as set forth in SEQ ID NO:4 wherein a fragment of the C-linker (SEQ ID NO:6) was modified to express the CS1 peptide, fabricated on cellulose-coated glass, following interaction with fluorescence-labeled Jurkat T-cells expressing a receptor recognizing the CS1 peptide.

FIG. 13 illustrates microarrays of immobilized proteins comprising the amino acid sequence as set forth in SEQ ID NO:4 chemically bound to biotin, following washing with various urea concentrations (0M, A; 1M, B; 3M, C; 6M, D), and the average fluorescence signal obtained from interacting the immobilized proteins with streptavidin alexa fluor 546® (E).

FIG. 14 shows microarrays of immobilized proteins comprising SEQ ID NO:4 chemically bound to biotin, following washing with various SDS concentrations (0%, A; 0.5%, B; 1%, C; 3%, D) and the average fluorescence signal obtained from interacting the immobilized proteins with streptavidin alexa fluor 546® (E).

FIG. 15 presents microarrays of immobilized proteins comprising the amino acid sequence as set forth in SEQ ID NO:4 chemically bound to biotin, following washing with various Tween® 20 concentrations (0%, A; 0.3%, B; 1.5%, C; 3%, D), and the average fluorescence signal obtained from interacting the immobilized proteins with streptavidin alexa fluor 546® (E).

FIG. 16 illustrates a microarray of immobilized oligonucleotides conjugated to the Cysteine 55 of proteins comprising the amino acid sequence as set forth in SEQ ID NO:4 (upper panel). The signal reflects interaction of complementary Cy5-oligonucleotide probe with the conjugated oligonucleotide-protein.

FIG. 17 is a schematic description of the construct used to encode a microarray comprising an immobilized library of peptides (A), a scheme of an immobilized library of peptides (B) and the corresponding image of the immobilized peptide library detected by Cy5-labeled rabbit anti SEQ ID NO:4 (C).

FIG. 18 presents fluorescence images of microarrays comprising immobilized proteins comprising the amino acid sequence as set forth in SEQ ID NO:4 and fusion proteins (ZEPHYRIN-ZZ) detected by Cy5-rabbit IgG (A) and the corresponding linear regression analysis (B).

FIG. 19 demonstrates fluorescence images of microarrays comprising and immobilized proteins, each protein comprising the amino acid sequence as set forth in SEQ ID NO:4 and biotin attached to the C-terminus of said amino acid sequence following incubation with streptavidin (A) and the corresponding signal intensity per location (B).

FIG. 20 presents serum level of HIV in infected and healthy individuals using ZEPHYRIN36, ZEPHYRIN41 and ZEPHYRIN LP56-41.

FIG. 21 is an image of ZEPHYRIN-ZZ based antibody microarray containing four different antibodies directed against ion-channels (A′-D′). The guide spot, positive control, of biotinylated-SEQ ID NO:4 was detected by Cy-5 labeled avidin (E) and the ZEPHYRIN-ZZ-antibodies were detected by ion-channels peptides labeled with Cy3 (A-D).

FIG. 22 shows the signal intensity generated by detection of labeled antigens detected by antibodies fabricated by conventional microarrays (P2X1, P2X2, HCN2, GABA, GST, SAV) and on the microarrays of the present invention (NC1 and RC).

FIG. 23 shows the background intensity generated by detection of labeled antigens detected by antibodies fabricated by conventional microarrays (P2X1, P2X2, HCN2, GABA, GST, SAV) and on the microarrays of the present invention (NC1 and RC).

FIG. 24 shows the signal-to-noise ratio generated by various labeled antigens detected by antibodies fabricated on conventional microarrays (P2X1, P2X2, HCN2, GABA, GST, SAV) and on the microarrays of the present invention (NC1 and RC).

### DETAILED DESCRIPTION OF THE INVENTION

### A. Definitions

The term “a polypeptide comprising a cellulose binding region” as used herein refers to a polypeptide or a protein comprising an amino acid sequence having a substrate binding region of a polysaccharidase.

Preferably the cellulose binding region is obtained from Clostridium thermocellum or another microorganism, providing that it has essentially no cellulase activity. Cellulase is a hydrolase of cellulose and is capable of digesting cellulose.

As used herein, the term “a member of a polysaccharidase family” refers to any enzyme that is capable of facilitating the hydrolysis of a polysaccharide, including but not limited to cellulose, pectin, alginate, chitin, etc. The members of the polysaccharidase family are not necessarily characterized by similar structural motifs, but rather are exemplified by the functionality described herein. Exemplary members of the polysaccharidase family are: polysaccharidases, cellulases and chitinases among others.

The term “printing” as used herein is to be construed in its most general sense and refers to deposition of droplets, e.g. droples containing the chimeric proteins of the invention, onto a suitable solid surface using any printing technology known in the art.

The term “cellulose polymer” or “a polymer comprising cellulose” as used herein refers to homopolymers of cellulose comprising cellulose or modified cellulose, such as nitrocellulose, microcrystalline cellulose and etc., or to hetero-polymers which comprise various polysaccharides, in different ratios. The polysaccharides may be artificial or natural. Examples, without limitation, of cellulose polymers are cellulose acetate, microcrystalline cellulose, lignin, starch and xylane.

A “library” refers to a collection of distinct molecules, preferably bioactive moieties, such as peptides, polypeptides, proteins, hormones or hormone precursors, carbohydrates, lipids, glycolipids, polynucleotides fusion proteins, more preferably chimeric proteins comprising a cellulose binding region an at least one exogenous biologically active molecules. The chimeric proteins may be recombinant or chemically synthesized. Molecules in the library are preferably spatially separated into distinct compartments prior to screening and are immobilized onto a solid surface after screening for the purpose of detection. Immobilization is carried out in an addressable manner.

A “bioactive” or “biologically active” moiety is any compound, either man-made or natural, that has an observable effect on a cell, a cell component or an organism. The observable effect is the “biological activity” of the compound.

The term “linker” or “native linker” as used herein refers to the C-terminus and/or the N-terminus sequence which flanks the cellulose binding region but has essentially no cellulose binding activity.

The term “variant” as used herein refers to a protein that possesses at least one modification compared to the original protein. Preferably, the variant is generated by modifying the nucleotide sequence encoding the original protein and then expressing the modified protein using methods known in the art. A modification may include at least one of the following: deletion of one or more nucleotides from the sequence of one polynucleotide compared to the sequence of a related polynucleotide, the addition of one or more nucleotides or the substitution of one nucleotide for another. Accordingly, the resulting modified protein may include at least one of the following modifications: one or more of the amino acid residues of the original protein are replaced by different amino acid residues, or are deleted, or one or more amino acid residues are added to the original protein. Other modification may be also introduced, for example, a peptide bond modification, cyclization of the structure of the original protein. A variant may have an altered binding ability to a cellulase substrate than the original protein. A variant may have at least 50% identity with the original cellulose binding region, preferably at least 60% or at least 70% identity.

The terms “polypeptide”, “peptide” and “protein” are used interchangeably to refer to polymers of amino acids of any length. These terms also apply to amino acid polymers in which one or more amino acid residues is an artificial chemical analogue of a corresponding naturally occurring amino acid, as well as to naturally occurring amino acid polymers. An amino acid polymer in which one or more amino acid residues is an “unnatural” amino acid, not corresponding to any naturally occurring amino acid, is also encompassed by the use of the terms “protein”, “peptide” and “polypeptide” herein.

As used herein, the terms “chimeric protein” as used herein refers to a modified protein, particularly a protein comprising a cellulose binding region and at least one exogenous biologically active moiety introduced therein or a fusion protein which comprises a cellulose binding region fused or covalently linked to at least one exogenous biologically active moiety. In preferred embodiments, the cellulose binding region is of SEQ ID NO:4 or variants thereof. In other preferred embodiments, the cellulose binding region further comprises at least one additional sequence selected from the group consisting of: SEQ ID NO:5 (corresponding to the N-terminus linker of SEQ ID NO:4), SEQ ID NO:6 (corresponding to the C-terminus linker of SEQ ID NO:4). In some embodiments of the present invention, the chimeric protein may be fused or joined to a second bioactive moiety.

“Fusion” refers to the joining together of a polynucleotide encoding a protein comprising a cellulose binding region and a polynucleotide encoding a biologically active moiety, in frame. Expression of the joint polynucleotides results in a chimeric protein also named hereinafter a “fusion protein”. The fusion protein of the present invention may comprise an enzymatic or chemical cleavage site upstream and preferably adjacent the N-terminus of the bioactive moiety and/or an enzymatic or chemical cleavage site downstream and preferably adjacent the C-terminus of the cellulose binding region thereby providing a means for recovering the bioactive moiety from the fusion protein through use of a cleaving agent.

“Covalently linking” refers to the binding of a protein comprising a cellulose binding region to a molecule using chemical modifications such as addition of bridging groups and the like, to facilitate the binding. Methods of covalently linking molecules are known by those skilled in the art.

Examples of biological active moieties include enzymes, such as nucleic acid modification enzymes, proteases, peptides, polypeptides, antibodies, antigens, antigenic epitopes and fragment and variants thereof, polynucleotides, hormones, carbohydrates, lipids, phospholipids and biotinylated probes.

The term “X% homology” is not intended to be limited to sequences having an X% homology over the entire length of the protein but is intended to include X% homology occurring in identified functional areas within the cellulose binding region and is also intended to include a functional area within the cellulose binding region which has the ability to bind cellulose with high affinity. Moreover, X% homology refers to the cellulose binding region excluding any exogenous moiety introduced therein.

As used herein, the terms “label” or “labeled” refers to incorporation of a detectable marker, e.g., by incorporation of a radiolabeled amino acid or attachment to biotin moieties that can be detected by marked avidin (e.g. streptavidin containing a fluorescent marker or enzymatic activity that can be detected by optical or calorimetrically methods). Various methods of labeling molecules are known in the art and may be used. Examples of labels include, but are not limited to, the following: radioisotopes (e.g., ³H, ¹⁴C, ³⁵S, ¹²⁵I, ¹³¹I), fluorescent labels (e.g., FITC, rhodamine, lanthanide phosphors), enzymatic labels (e.g., horseradish peroxidase, β-galactosidase, luciferase, alkaline phosphatase), biotinyl groups, predetermined epitopes recognized by a secondary reporter (e.g., leucine zipper pair sequences, binding sites for secondary antibodies, transcriptional activator polypeptide, metal binding domains, epitope tags).

“Nucleic acid” or “polynucleotide” refers to a nucleotide sequence comprising a series of nucleic acids in a 5′ to 3′ phosphate diester linkage that may be either an RNA or a DNA sequence. If the nucleic acid is DNA, the nucleotide sequence is either single or double stranded. A nucleic acid encoding the protein of the invention is RNA or DNA that encodes a protein capable of binding cellulose with high affinity, is complementary to nucleic acid sequence encoding such protein, or hybridizes to nucleic acid sequence encoding such protein and remains stably bound to it under stringent conditions.

As used herein, a “recombinant” nucleic acid or protein molecule is a molecule where the nucleic acid molecule which encodes the protein has been modified in vitro, so that its sequence is not naturally occurring, or corresponds to naturally occurring sequences that are not positioned as they would be positioned in a genome which has not been modified.

By “vector” is meant a polynucleotide molecule, preferably a DNA molecule derived, for example, from a plasmid, bacteriophage, or plant virus, into which a polynucleotide can be inserted or cloned. A vector preferably contains one or more unique restriction sites and can be capable of autonomous replication in a defined host cell including a target cell or tissue or a progenitor cell or tissue thereof, or be integrable with the genome of the defined host such that the cloned sequence is reproducible. The choice of the vector will typically depend on the compatibility of the vector with the host cell into which the vector is to be introduced. The vector can also include a selection marker such as an antibiotic resistance gene that can be used for selection of suitable transformants. Examples of such resistance genes are known to those of skill in the art and include the nptII gene that confers resistance to the antibiotics kanamycin and G418 (Geneticin™) and the hph gene which confers resistance to the antibiotic hygromycin B. A vector according to the present invention is used for expression of the protein(s) comprising cellulose binding region. Thus, “an expression vector” refers to a vector containing nucleotide sequences containing transcriptional and translational regulatory information and such sequences are operably linked to nucleotide coding sequences.

As used herein, the term “operably linked” refers to a linkage in which the regulatory DNA sequences and the DNA sequence to be expressed are connected in such a way as to permit transcription and ultimately translation.

The term “host cell” refers to those cells capable of growth in culture and capable of expressing a protein or a fusion protein comprising a cellulose binding region. The host cells of the present invention encompass cells in vitro culture and include prokaryotic, eukaryotic, and insect cells. A host cell strain may be chosen which modulates the expression of the inserted sequences, or modifies and processes the gene product in the specific fashion desired. Expression from certain promoters can be elevated in the presence of certain inducers (e.g., zinc and cadmium ions for metallothionine promoters). Therefore expression of the protein or fusion protein of the invention may be controlled. The ability to control expression will be important if the protein or fusion protein is lethal to a host cell. Modifications (e.g., phosphorylation) and processing (e.g., cleavage) of protein products are important for the function of the protein. Different host cells have characteristic and specific mechanisms for the post-translational processing and modification of protein. Appropriate cell lines or host systems can be chosen to ensure the correct modification and processing of the protein or fusion protein expressed. Preferably, the host cell should secrete minimal amounts of proteolytic enzymes.

### B. Preferred Modes for Carrying Out the Invention

(i) Cloning and Expression of Proteins Comprising Cellulose Binding Regions

Microarray technology is currently a preferred method for the efficient study and characterization of a large repertoire of genes and proteins. Typically, microarrays consist of an ordered arrangement of known biological active elements, immobilized on a substrate. The present invention provides a microarray platform in which the screening procedure is advantageously carried out prior to immobilizing the products onto a solid support. The libraries and assays of the present invention are suitable for detection and screening of desired biological moieties, and are particularly suitable for high throughput protocols.

The present invention provides a library comprising a plurality of proteins comprising a cellulose binding region, capable of attaching to a cellulase substrate with high affinity, and a biologically active moiety.

In certain embodiments, the libraries of the present invention comprise a plurality of chimeric proteins comprising cellulose binding region wherein the cellulose binding region is modified such that it contains at least one exogenous biologically active moiety introduced therein, fused thereto or chemically conjugated thereto, without impairing the capacity of the chimeric proteins to bind cellulase substrates with high affinity.

The library of chimeric proteins may be prepared by transforming into host cells a plurality of DNA constructs, each construct comprising a DNA encoding a cellulose binding region wherein said region further contains at least one DNA fragment encoding an exogenous biologically active moiety and growing the host cells to express the library of chimeric proteins.

Each biologically active moiety is selected from the group consisting of: peptides, polypeptides, including enzymes, antibodies and fragments thereof, antigenic epitopes, polynucleotides, hormones, carbohydrates, lipids, phospholipids and biotinylated probes.

According to a preferred embodiment, the biologically active moiety is a peptide. The exogenous peptides may comprise a sequence of about 5 to 150 amino acid residues, about 15 to 100 amino acid residues and of about 18 to 50 amino acids.

The biologically active moieties are introduced to the cellulose binding regions at predetermined sites such that the resulting chimeric proteins maintain the ability to bind cellulose with high affinity. Examples of sites, other than the C-terminus or the N-terminus, which may be selected for modification in a cellulose binding region derived from Clostridium Therinocellum (i.e. SEQ ID NO:4) are: loop 5/6 located between β-strand 5 and β-strand 6, a loop between β-strand 7 and β-strand 8, a loop between β-strand 8 and β-strand 9, a loop between β-strand 3 and β-strand 4, the residues that form a second conserved site located in a shallow groove opposite to the cellulose-binding surface.

Chimeric proteins comprising protein-based exogenous moieties may be prepared by transforming into a host cell a DNA construct comprising a DNA fragment encoding a cellulose binding region and the peptide of interest and growing the host cell to express the chimeric protein.

In certain embodiments, the libraries of the present invention comprise a plurality of chimeric proteins comprising a cellulose binding region and at least one biologically active moiety covalently linked to the cellulose binding region.

In some embodiment, the libraries of the present invention comprise a plurality of proteins, each protein comprising a cellulose binding region and at least two biologically active moieties. The at least two biologically active moieties may be the same or different from one another.

In those embodiments where the at least two biologically active moieties of each chimeric protein are different from one another, the library is particularly useful for screening biological interactions between ligands and receptors which are mediated by a third component. For example, the interaction of growth factors and their receptors may involve additional necessary components, as in the case of fibroblast growth factor (FGF) binding to FGF receptor that is mediated by both a protein-protein interaction and a protein-oligosaccharide interaction.

The library of polynucleotides encoding the library of chimeric proteins of the present invention comprises nucleic acid sequences of genomic, cDNA, synthetic, and semi-synthetic origin which, by virtue of its origin or manipulation, may be linked to a polynucleotide other than that to which it is linked in nature, and includes single or double stranded polymers of ribonucleotides, deoxyribonucleotides, nucleotide analogs, or combinations thereof, as long as the protein being encoded retains the ability to bind cellulose with high affinity. The nucleic acid encoding the protein of the present invention also includes various modifications known in the art, including but not limited to radioactive and chemical labels, methylation, caps, internucleotide modifications such those with charged linkages (e.g., phosphorothioates, phosphorodithioates, etc.) and uncharged linkages (e.g., methyl phosphonates, phosphotriesters, phosphoramidites, carbamites, etc.), as well as those containing pendant moieties, interchelators, chelators, etc. as long as the protein encoded by the nucleic acid retains the ability to bind cellulose with high affinity and in a reversible manner.

The nucleic acid encoding a protein comprising a cellulose binding region may be obtained from a variety of cell sources that produce a protein comprising cellulose binding regions that bind with high affinity and in a reversible manner or that produce mRNA encoding such protein. The preferred source of a nucleic acid encoding a protein comprising a cellulose binding region is Clostridium Thermocellum.

In another preferred embodiment, the libraries of present invention encompass a plurality of proteins comprising a cellulose binding region wherein the cellulose binding region is encoded by a polynucleotide comprising the nucleic acid sequence of SEQ ID NO:1 or fragments thereof. The fragments encode proteins capable of binding cellulase substrates, even when a sequence of an exogenous protein is introduced therein.

According to another preferred embodiment, the polynucleotide comprises a nucleic acid sequence having at least 80% homology, preferably about 90% homology, to the nucleic acid sequence of SEQ ID NO:1.

Optionally, the nucleic acid sequence encoding a cellulose binding region may further comprises at least one of the native linkers flanking the N/C-termini of the cellulose binding region. Thus, nucleic acid sequence encoding a protein comprising a cellulose binding region comprising the nucleic acid sequence of SEQ ID NO:1 or fragments thereof may further comprise at least one additional nucleic acid sequence selected from the group consisting of: SEQ ID NO:2 (corresponding to the N-terminus linker of SEQ ID NO:1), SEQ ID NO:3 (corresponding to the C-terminus linker of SEQ ID NO:1).

In other preferred embodiments, the libraries of the present invention comprise a plurality of chimeric proteins comprising an amino acid sequence of SEQ ID NO:4. Optionally, the libraries of the present invention comprise a plurality of chimeric proteins comprising a cellulose binding region of an amino acid sequence having at least 80% homology, to the amino acid of SEQ ID NO:4.

The plurality of chimeric proteins comprising an amino acid sequence of SEQ ID NO:4 may further comprise at least one additional amino acid sequence selected from the group consisting of: SEQ ID NO:5 and SEQ ID NO:6.

It is to be understood explicitly that the scope of the present invention encompasses homologs, analogs, variants and derivatives, including shorter and longer proteins and polynucleotides, as well as protein and polynucleotide analogs with one or more amino acid or nucleic acid substitution, as well as amino acid or nucleic acid derivatives, non-natural amino or nucleic acids and synthetic amino or nucleic acids as are known in the art, with the stipulation that these modifications must preserve the capacity of binding cellulose of the original molecule in the context of the libraries of the present invention. Specifically any active fragments of the active protein as well as extensions, conjugates and mixtures are disclosed according to the principles of the present invention.

A preferred strategy for generating chimeric proteins comprising biologically active moieties is by introducing random or deliberate mutations within at least one of the linkers which flank the cellulose binding region.

Mutations in a nucleic acid sequence can be created through site-directed mutagenesis, also termed herein “deliberate mutagenesis”, or through random mutagenesis as known in the art. Random mutagenesis may be generated by error-prone PCR including the use of polymerase of increased mutagenic activity, the addition of disproportional amount of a given nucleic acid and the like. Another useful procedure for performing such mutagenesis is called “DNA shuffling” (see Harayama, S., Trends Biotechnol., 1998, 16:76-82). For generating a library of peptides the C-terminus linker or the N-terminus linker of the protein of the present invention may be randomly mutated. Preferably, the resulting library of peptides is immobilized onto a solid surface comprising a polymer comprising cellulose such that the various peptides are exposed, and preferably oriented so as to be accessible to the external environment or medium while the cellulose binding region is attached to said solid surface.

Site-directed mutagenesis of specific nucleotides can be used to create mutant linkers with particular properties using methods such as a closing oligonucleotide method described previously (Slilaty et al., 1990, Anal. Biochem. 185:194-200) and mutagenic oligonucleotide. Oligonucleotides may be synthesized by standard methods known in the art, e.g. by use of an automated DNA synthesizer (such as are commercially available from Biosearch, Applied Biosystems, etc.). According to some preferred embodiments, the site-directed mutagenesis is at the C-terminus linker (e.g. SEQ ID NO:3 encoded by SEQ ID NO:6) wherein the polynucleotide sequence encoding the C-terminus linker is modified such that it encodes a fragment of an HIV type 1 or type 2 antigen such as gp36 (for HIV type 2) resulting in a protein called herein ZEPHYRIN36, gp41 (for HIV type 2) resulting in a protein called herein ZEPHYRIN41, gp120 (for HIV type 1) resulting in a protein called herein ZEPHYRIN120; in other preferred embodiment of the present invention, the C-terminus linker (SEQ ID NO:3) is mutated to express a ZZ domain protein (Nord et al., Protein Eng. 1995 8:601) resulting in a protein called herein ZEPHYRIN-ZZ.

The polynucleotides encoding the protein libraries of the present invention may be used to construct recombinant expression vectors capable of expressing the protein(s). In constructing an expression vector for a chimeric protein, the nucleic acid encoding the protein comprising a cellulose binding region will be operably linked or joined to the nucleic acid encoding the biologically active moiety such that the open reading frame of the protein comprising a cellulose binding region and the biologically active moiety is intact, allowing translation of the chimeric protein to occur.

Many vectors are available, and selection of the appropriate vector will depend on whether it is to be used for nucleic acid amplification or for nucleic acid expression, the size of the nucleic acid to be inserted into the vector, and the host cell to be transformed with the vector. Transfection of the host cell can be effected in a number of ways well known to those of ordinary skill in the art, including, but not limited to, electroporation, injection, calcium chloride precipitation and retroviral introduction. Furthermore, the nucleic acid can be either integrated with the genome of the hose cell or not.

Each vector contains various components depending on the function (amplification of nucleic acid or expression of nucleic acid) and the host cell for which it is compatible.

The preferred host cell for cloning and expression of the protein libraries of the present invention is a prokaryotic cell. Prokaryotes are particularly useful for rapid production of large amounts of nucleic acid, for production of single-stranded nucleic acid templates used for site-directed mutagenesis, for screening many mutants simultaneously, and for nucleic acid sequencing of the mutants generated. An example of a prokaryotic cell useful for cloning and expression of the protein libraries of the present invention is E. Coli strain BL21 (DE3; Novagen, WI, USA).

Various expression vector/host systems may be utilized equally well by those skilled in the art for the recombinant generation of the protein libraries of the present invention. Such systems include but are not limited to microorganisms such as bacteria transformed with recombinant bacteriophage DNA, plasmid DNA or cosmid DNA expression vectors containing the desired coding sequence; yeast transformed with recombinant yeast expression vectors containing the desired coding sequence; insect cell systems infected with recombinant virus expression vectors (e.g., baculovirus) containing the desired coding sequence; plant cell systems infected with recombinant virus expression vectors (e.g., cauliflower mosaic virus CaMV; tobacco mosaic virus, TMV) or transformed with recombinant plasmid expression vectors (e.g., Ti plasmid) containing the desired coding sequence; or animal cell systems infected with recombinant virus expression vectors (e.g. adenovirus, vaccinia virus) including cell lines engineered to contain multiple copies of the desired nucleic acid either stably amplified (e.g., CHO/dhfr, CHO/glutamine synthetase) or unstably amplified in double-minute chromosomes (e.g., murine cell lines).

Vector components generally include, but are not limited to, one or more of the following: a signal sequence, an origin of replication, one or more marker genes, an enhancer element, a promoter, and a transcription termination sequence. The expression elements of these vectors vary in their strength and specificities. Depending on the host/vector system utilized, any one of a number of suitable transcription and translation elements may be used. For example, when cloning in prokaryotic cell systems, promoters isolated from the genome of prokaryotic cells, (e.g., the bacterial tryptophan promoter) may be used. Promoters produced by recombinant DNA or synthetic techniques may also be used to provide for transcription of the inserted sequences.

A signal sequence may be a component of the vector, or it may be a part of the nucleic acid encoding the protein library of the invention, that is inserted into the vector. The signal sequence may be the naturally occurring sequence or a non-naturally occurring sequence. The signal sequence should be one that is recognized and processed by the host cell. An origin of replication refers to the unique site of initiation of replication of a host organism. It is desirable for cloning and expression vectors to comprise a selection gene, also termed a selectable marker. This gene encodes a protein necessary for the survival or growth of transformed host cells grown in a selective culture medium. Host cells not transformed with the vector containing the selection gene will not survive in the culture medium. Typical selection genes encode proteins that confer resistance to antibiotics or other toxins, e.g. ampicillin; complement auxotrophic deficiencies; or supply critical nutrients not available from complex media. One example of a selection scheme utilizes a drug to arrest growth of a host cell. Those cells that are successfully transformed with a heterologous gene express a protein conferring drug resistance and thus survive the selection regimen. Expression vectors used in prokaryotic host cells will also contain sequences necessary for the termination of transcription and for stabilizing the mRNA.

Construction of suitable vectors containing one or more of the above listed components and including the desired coding and control sequences employs standard ligation techniques. Isolated plasmids or nucleic acid fragments are cleaved, tailored, and religated in the form desired to generate the plasmids required.

Host cells are transfected and preferably transformed with the above-described expression or cloning vectors of this invention and cultured in conventional nutrient media modified as appropriate for inducing promoters, selecting transformants, or amplifying the genes encoding the desired sequences. An advantage of the cellulose binding proteins of the present invention is the simplicity of their production. The cellulose binding proteins of the invention are secreted to the growth medium or preferably accumulate in a soluble form within the cell. The proteins of the present invention do not tend to form inclusion bodies in the cytoplasm of E. Coli like for example proteins comprising a cellulose binding domain derived from Clostridium Cellulovorans.

(ii) Libraries, Kits and Assays

The libraries of the present invention comprise a plurality of proteins comprising a cellulose binding region. The libraries of the present invention may be provided in a kit comprising a plurality of distinct compartment, each compartment comprising a chimeric proteins, preferably each compartment is addressable.

The present invention also relates to methods for using the libraries of chimeric proteins. Particularly, the present invention provides assays for high throughput screening, wherein the initial step of each assay includes screening the library of the chimeric proteins for a desired activity or function, including but not limited to, the ability to specifically bind to an antibody, a receptor or other molecules.

The screened library is then immobilized onto a solid substrate that is capable of binding to the cellulose binding region and finally identification of the at least one exogenous biologically active moiety having the desired activity or function is carried out.

“Immobilization of the screened library”, onto a substrate capable of binding to the cellulose binding region within the chimeric proteins of the library, is also termed herein “fabrication” or “printing”. Fabrication of the screened library of the present invention is simple and straightforward due to the following advantages:
(a) Attachment of the chimeric proteins comprising a cellulose binding region to the solid support does not require any chemical modification of the chimeric protein, due to the high affinity of the cellulose binding region to its substrates, (cellulose and the like).
(b) Fabrication of the chimeric proteins of the libraries of the present invention does not require purification of said proteins prior to their attachment onto a substrate capable of binding a cellulose binding region.
(c) In some embodiments, the present invention provides a kit consisting essentially cellulose and protein library comprising a plurality of chimeric proteins comprising a cellulose binding region. Fabrication of such chimeric proteins is simple and does not require additional steps such as coating and adhesion.

Technologies allowing the deposition of droplets containing proteins comprising cellulose binding regions onto a suitable solid surface are known in the art. An ink-jet printing technology for deposition of small droplets while avoiding overlap or splatter is disclosed in U.S. Pat. No. 5,449,754. This technology is particularly effective for creating peptide microarrays. Any other contact spotter or arrayer that deposits droplets comprising proteins comprising a cellulose binding region onto a solid surface comprising cellulose polymer are suitable for the working of the present invention.

For fabricating the complexes formed at the screening stage, it is not required to purify the proteins comprising cellulose binding regions prior to their attachment to a support comprising cellulase substrate, as exemplified hereinbelow. This property of the libraries and assays of the present invention is particularly practical for the when screening and printing a large library of proteins.

In order to conduct microarray assays, the sample of interest is mixed with the library of chimeric peptides. Preferably, the library is organized such that each chimeric protein is in a distinct compartment. Preferably, the mixtures of the sample of interest and the chimeric proteins are addressed. Following incubation the mixtures are printed onto a solid surface containing a substrate which binds cellulose binding regions. Following printing, the immobilized mixtures are optionally washed, typically under conditions such that any complexes formed will remain immobilized on the solid surface and unbound material will be removed.

The detection of complexes anchored on the solid surface can be accomplished in a number of ways. In some embodiments, the non-immobilized complex is pre-labeled, and the detection is directed wherein the label directly indicates that complexes between the libraries and the screened molecule were formed. In other embodiments, the non-immobilized complex is not pre-labeled and an indirect label is used to detect immobilized complexes e.g., using a labeled antibody specific for the screened substance.

A critical feature of a direct detection of the screened libraries of the invention is the presence of an amount of a label is proportional to the amount of molecule that is labeled.

Virtually any label that produces a detectable, quantifiable signal and that is capable of being attached to proteins contained within the libraries of the invention or the sample to be analyzed, can be used. Suitable labels include, by way of example and not limitation, radioisotopes, fluorophores, chromophores, chemiluminescent moieties, etc. In embodiments where the label is attached to a polynucleotide, the label can be attached to any part of the polynucleotide, including the free terminus or one or more of the bases. Preferably, the position of the label will not interfere with interaction between a desired sample and the molecules of the library. Suitable methods of making labeled molecules are well known in the art. One of the preferred labels is biotin.

In the case where each component in the libraries of the invention, or each substance that screens the library of the invention, contains an amount of a label or “tracer” proportional to the amount of molecules immobilized at the particular spot, after the screening procedure, the signals obtained from the immobilized molecules can be normalized. As a consequence, signal intensities from various assays can be directly compared. A normalized signal of a particular spot comprising immobilized molecules may be defined by (Iₜ−I₀)/I₀, where Iₜ is the intensity of the signal of the spot after contacting with a sample of interest and I₀ is the intensity of the background signal of the spot before printing.

Various methods and devices for detection and analysis of the screened library, which contains immobilized chimeric proteins, are known in the art. Practically, any imaging system that is capable of detecting with a resolution appropriate to the size of the array features can be utilized. Imaging apparatus may be selected, without any limitation, from ScanArray 4000 (General Scanning), Biochip Imager (Hewlett Packard), GMS 418 Array Scanner (Genetic Microsystems), GeneTAC 1000 (Genomic Solutions), Chip Reader (Virtek). Phosphorimager systems are available for detecting radiolabels, e.g. Cyclone (Packard Instrument company) and BAS-5000 (Fujifilm).

The libraries of the present invention are particularly suitable as libraries of peptides, antibodies, DNA and chemical moieties. The advantage of the libraries and assays of the present invention is that the detection step is enabled even with a screened library consisting of non purified components, as exemplified hereinbelow, and hence provides an ideal platform for applications which require a large workload at high speed, high sensitivity and low cost.

The assays of the invention are useful with unlabeled libraries as well as with labeled libraries following an interaction with a secondary labeled target. A main requirement in such assays is that a detectable signal efficiently indicates recognition and/or interaction between the components of the protein library and the sample of interest.

The present invention provides a kit comprising:
(a) a plurality of discrete compartments, each compartment comprising a chimeric protein, the chimeric protein comprising a cellulose binding region devoid of cellulolytic activity and at least one exogenous biologically active moiety; and, optionally,
(b) a solid support having a surface, the surface comprising a substrate capable of binding the cellulose binding region.

According to one embodiment, the cellulose binding region is derived from a protein other than a member of the polysaccharidase family. According to another embodiment, the cellulose binding region is derived from the non-cellulolytic cellulosomal scaffolding Protein A subunit of Clostridium thermocellum.

According to an alternative embodiment, the cellulose binding region comprising an amino acid sequence having at least 80% homology, preferably at least 90% homology, to SEQ ID NO:4, wherein the cellulose binding region may further comprise at least one additional amino acid sequence having at least 80% homology, preferably at least 90% homology, to any one of the sequences selected from the group consisting of: SEQ ID NO:5 and SEQ ID NO:6.

According to another alternative embodiment, the cellulose binding region is encoded by a polynucleotide sequence comprising a nucleotide sequence having at least 80% homology, preferably at least 90% homology to SEQ ID NO:1, wherein the polynucleotide sequence may further comprise at least one additional polynucleotide sequence having at least 80% homology, preferably having at least 90% homology to the any one of the nucleotide sequences selected from the group consisting of: SEQ ID NO:2 and SEQ ID NO:3.

According to yet another embodiment, the at least one biologically active moiety is selected from the group consisting of: peptides, polypeptides, including enzymes, antibodies and fragments thereof, antigenic epitopes, polynucleotides, hormones, carbohydrates, lipids, phospholipids and biotinylated probes.

According to a preferred embodiment, the biologically active moiety is a peptide. According to some embodiments, the peptide comprises a sequence of 5 to 50 amino acids.

According to another embodiment, the at least one exogenous biologically active moiety is introduced into the cellulose binding region at a predetermined location other than the C-terminus or the N-terminus of said cellulose binding region.

According to yet another embodiment, the at least one exogenous biologically active moiety is fused to the cellulose binding region at the C-terminus or the N-terminus of said cellulose binding region.

According to yet another embodiment, the at least one exogenous biologically active moiety is covalently linked to the cellulose binding region.

According to yet another embodiment, the surface of the solid support comprises cellulose polymers selected from the group consisting of: cellulose homopolymers, cellulose heteropolymers, cellulose acetate, microcrystalline cellulose, lignin, starch, xylane. According to yet another embodiment, the solid support comprises a material selected from the group consisting of: glass, ceramics, metal and plastics.

Typically, the kit essentially consists of a plurality of compartments, wherein each compartment contains a discrete chimeric protein. However, several compartments may comprise similar proteins, as in many applications redundancies are desirable particularly for the purposes of internal controls.

The solid surface may be in the form of beads, particles or sheets, and may be permeable or impermeable, depending on the type of array, wherein the surface is coated with a suitable material enabling binding of cellulose binding region at high affinity. The solid phase support may further comprise a wide variety of compositions, while maintaining the ability to bind a cellulose binding region at high specificity. The support may be linear or three-dimensional such as in the form beads or particles, fibers (such as glass wool or other glass or plastic fibers) or glass or plastic capillary tubes. It may be also in the form of chips, membranes, slides, plates or sheets in which at least one surface is substantially flat, wherein the surface comprises a suitable material enabling binding of cellulose binding region at high affinity. The support may consist plastic, glass, plastic, silicon, low cross-linked and high cross-linked polystyrene, silica gel, polyamide, and the like. Preferred solid support for use with the assays of the present invention include, by a way of a non-limiting example, glass slides coated with cellulose.

The solid support may be of any desired size. The upper and lower limits on their size are determined solely by the practical considerations of resolution, size of molecules at each address and the like.

The nature and geometry of the solid surface will depend upon a variety of factors, including, among others, the type of support (e.g., one-dimensional, two-dimensional or three-dimensional). Generally, the surface can be composed of any material which permits immobilization of the chimeric proteins of the libraries of the invention and which will not melt or otherwise substantially degrade under the conditions used in the applications of the libraries.

A number of materials suitable for use as surfaces in the instant invention have been described in the art. Exemplary suitable materials include cellulose homopolymers and cellulose heteropolymers, selected from cellulose acetate, microcrystalline cellulose, lignin, starch, xylane.

Having now generally described the invention, the same will be more readily understood through reference to the following examples, which are provided by way of illustration and are not intended to be limiting of the present invention. It is to be understood that examples of arrays or microarrays comprising the libraries of the invention are provided merely to emphasize the feasibility and quality of the detection step in the methods of the invention.

### EXAMPLES

### Materials and Methods

Lysate biotinamidocaproate n-hydroxysuccinimide ester, isopropyl β-d-thiogalactopyranoside was purchased from SIGMA Chemical Co., St. Louis, Mo., USA. Peroxidase-conjugated rabbit anti-human IgG, peroxidase-conjugated rabbit anti-human IgA, peroxidase-conjugated rabbit anti-human IgM and Cy3 goat anti human IgG was from Jackson Immunoresearch, Inc., PA, USA. Cyto 82 were from molecular probes, Eugene, Oreg., USA. Mouse anti his6-tag was from Serotec Ltd, Oxford, UK. T7 RNA polymerase was from Novagen, Madison, Wis., USA. (sulfosuccinimidyl 4-[n-maleimmidomethyl]-cyclohexane-1-carboxylate) (Sulfo-SMCC) was purchased from Pierce, Rockford, Ill., USA. 5′-end amino modified oligonucleotide and 5′-end Cy5 oligonucleotide probes were synthesized by IDT, inc. Coralville, Iowa, USA.

The principles of the invention are exemplified hereinbelow using a microarray which comprises a protein comprising a cellulose binding region derived from Clostridium Thermocellum. It is explicitly intended that the microarrays and methods of the invention are applicable to a wide variety of proteins comprising a cellulose binding region.

### Protein Purification by Cellulose Affinity Chromatography

Bacterial cells (100 ml of induced culture) from BL21 (DE3) carrying plasmid pET3d-ZEPHYRIN36 and induced for 16 hr with 0.1 mM IPTG were centrifuged and the pellet was suspended in 10 ml and disrupted by sonication, 40% amplitude, 5 cycles of 2 min each). Total cell extract was centrifuged at 15,000 g for 15 min at 4° C., and the soluble fraction was collected. Aliquots of 1 gram of microcrystalline cellulose was added into the soluble fraction and the mixture was maintained for 1 hr at room temperature under continuous stirring following centrifugation at 10,000 g for 5 min at 4° C. The supernatant was discarded and the cellulose pellet was resuspended and washed with 40 ml PBS containing 1M NaCl. This washing procedure, with high salt concentration, was repeated twice and was followed by two sequential washing steps with PBS. The ZEPHYRIN36 was eluted from the cellulose by the addition of 5 ml 1% triethylamine. The eluted soluble protein was neutralized immediately by addition of 0.5 ml of 1M phosphate buffer pH 5.6. The purified protein was divided into small aliquot and stored at −20° C.

### Protein Purification by High Temperature Incubation

Bacterial cells (100 ml of induced culture) from BL21 (DE3) carrying plasmid pET3d-ZEPHYRIN36 and induced for 16 hr with 0.1 mM IPTG were centrifuged and the pellet was suspended in 10 ml and with 0.1 mM IPTG were centrifuged and the pellet was suspended in 10 ml and disrupted by sonication. The total cell extract was centrifuges at 15,000 g for 15 min at 4° C., and the soluble fraction was collected and saved. The soluble fraction was transferred into 70° C. water bath and allowed to incubate for 60 min. The sample was then centrifuged at 10,000 g for 5 min at 4° C. The purified protein was divided into small aliquot and stored at −20° C.

### Preparation of Microarrays

Double-sided adhesive tape was used for casting the plain glass slide (75 mm×25 mm) with various membranes. The casting of glass slide comprises two steps. In the first step, one side of the tape was used to stick on the tape on the glass slide and followed by exposing the second surface of the adhesive tape. In the second step, cellulose membrane (50 mm×18 mm) was carefully stuck on the exposed side. This step was accomplished by tightly pressing the membrane on the adhesive side using glass pipette. The cellulose membranes were prepared from either regenerated cellulose or from cellulose acetate.

A contact-printing manual spotter (MicroCaster slide microarrayer, Schleicher & Schuell Inc, NH, USA), equipped with 8 pin tool of 0.2 mm diameter, was used to apply spots of the protein samples in an ordered array onto the cellulose-coated glass slides. The spot-to-spot distance was about 0.2 mm and droplet volume was 2 nL.

Samples of proteins comprising a cellulose binding region, having the amino acid sequence of SEQ ID NO:4 were serially diluted in PBS or in crude E. Coli extract, before spotting. After fabrication the slides were allowed to dry at room temperature for 30 min and then either used immediately or stored in a 50-ml polypropylene tube, stored at 4° C.

### Assay Performance and Detection System

Fabricated microarray slides were removed from the 50-ml and were transferred into polypropylene slide container. The slides were then blocked with 2% BSA in PBS (4 ml per slide). After 60-min incubation at room temperature, the blocking solution was removed and residual solution was shaken off by tapping the slide over filter paper. Without allowing the microarray to dry a 4-ml aliquot of appropriate legend in 2% BSA/PBS was then added and allowed to react for 1 hr at room temperature under continuous mixing. The microarray slide was washed extensively with PBS/0.1% Tween-20 (five times, 4 min each) and if needed was reacted for additional hour with appropriate secondary antibody. After another washing step fluorescence signals measured using scan arrayer (ScanArray Lite, Perkin Elmer, MA, USA.).

### Cell Adhesion Assay

Jurkat T-cells, a human leukemia line, were grown under the appropriate growing conditions. Shortly before the adherence assay, cells were washed with 5 mM EDTA in Tris-buffered saline (TBS, 10 mM Tris-HCl, pH 7.4, 150 mM NaCl) and then incubated with Cyto 82 (2 μM final concentration) for 30 min under continuous agitation. Labeled cells were washed twice with the same buffer and applied directly on the fabricated microarray slides.

### Preparation of Crude E. Coli Extract

One liter of E. Coli culture, containing unrelated plasmid was centrifuged, and resuspended in 40 ml PBS. The cells were then sonicated on ice and centrifuged again. Supernatant was collected and diluted 4 times with 2% BSA in PBS. Small aliquots were stored at −20° C.

### Protein Biotinylation and Cy5 Labeling

Purified protein, which contains the amino acid sequence of SEQ ID NO:4, was biotinylated, using biotinamidocaproate N-hydroxysuccinimide ester or biotin maleimide at a 5-fold molar ratio of reagent to protein as described previously (2). Rabbit anti SEQ ID NO:4, XylanseT6CelS-dockerin and mouse anti-his6-tag were labeled with Cy5 according to the manufacturer instructions.

### ELISA Test

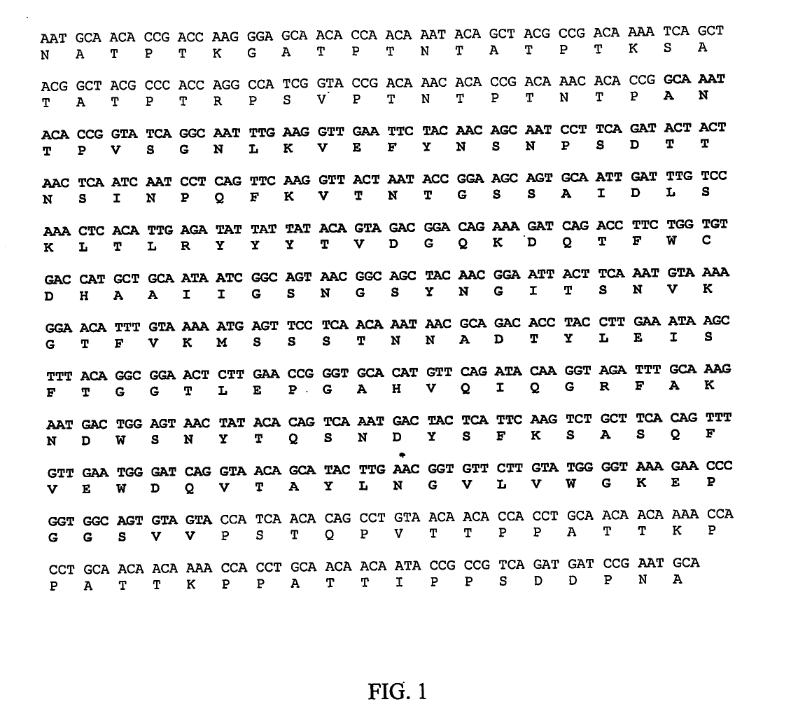

96-well microtiter plates (Maxisorp, Nunc) were coated by overnight incubation at 4° C. with a recombinant gp41 (1 μg/ml), a protein having SEQ ID NO:4 (5 μg/ml) and ZEPHYRIN41 fusion protein comprising both the recombinant gp41 and SEQ ID NO:4 (5 μg/ml) dissolved in 0.1NaHCO₃, pH8.1 (100 μl/well). The plates were washes once with PBS and blocked with 2% BSA/PBS (200 μl/well) for 1 hr at room temperature. Aliquots of 200 μl/well of healthy and HIV type 1 infected individuals serum diluted 1:100000 with 2% BSA/PBS were added to the wells and the plate was incubated for 1 hr at room temperature. The plates were washed subsequently 5 times with PBS/Tween20-0.1% and peroxidase-conjugated rabbit anti-human IgG, peroxidase-conjugated rabbit anti-human IgA and peroxidase-conjugated rabbit anti-human IgM diluted 1:10000 in 2% BSA/PBS was then applied to the wells for 1 hr at room temperature. Unbound antibody was removed by washing as describe before and the color was developed using TMB solution (100 ml/well). After 5 min the reaction was terminated by the addition of 1M H₂SO4 (50 μl/well) and the optical densities were measured at 450 nm. The cutoff value was determined as the mean value of 10 healthy individual serum sample (for the protein depicted in FIG. 1) plus 2 standard deviation values.

### Hybridization of Oligonucleotide Conjugates with Cy5-oligonucleotide probe

Arrays of cellulose binding regions (SEQ ID NO:4) non-conjugated and covalently bound to oligonucleotides attached to cellulose membranes were prepared and then washed for 30 min in room temperature with pre-hybridization solution (150 mM sodium citrate, 5× Denhardt's solution, pH8). The prehybridization solution was removed and hybridization solution (150 mM sodium citrate, 5× Denhardt's solution, pH8) containing 5 μg/ml of 5′ end Cy5 oligonucleotide probe was applied on the array. Following 3 h hybridization at 37° C. under continuous mixing, the array was washed twice in 100 mM sodium citrate pH8, 10 min each wash, following a brief rinse in 1×SSC.

### Example 1

### Cloning, Expression and Purification of a Cellulose Binding Recombinant Protein

A plasmid containing the gene encoding the cellulose binding region of Clostridium thermocellum cellulosome (SEQ ID NO:1) and its native N-terminus (SEQ ID NO:2) and C-terminus linkers, (SEQ ID NO:3) was used to transform E. Coli strain BL21 (DE3; Novagen, WI, USA). The transformed cells were grown on LB medium with appropriate antibiotics and IPTG (induction) for 12 to 18 hr at 16° C. without induction. Cell culture was centrifuged, resuspended in Tris buffer (50 mM, pH 7.2), sonicated and centrifuged again. Microcrystalline cellulose (Sigma Chemical Co., St. Louis, Mo., USA) was added to the clear supernatant, and the suspension was stirred for 1 h. After centrifugation, the pellet was washed once with phosphate-buffered saline (PBS) containing 1 M NaCl and twice with PBS. The recombinant protein was eluted from the cellulose matrix with 1% triethylamine, neutralized to pH 7 and stored at −20° C.

### Example 2

### Cloning, Expression and Purification of a Recombinant Fusion Protein

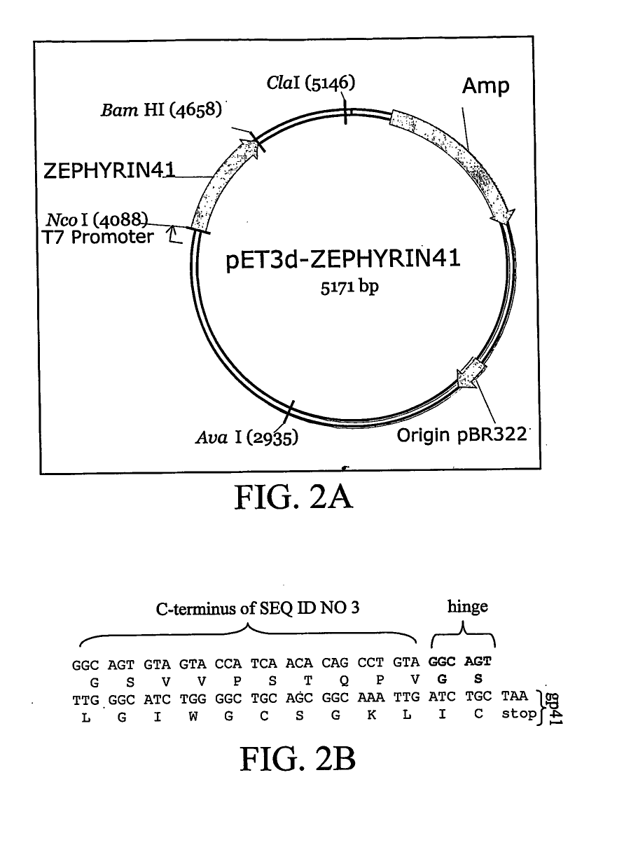

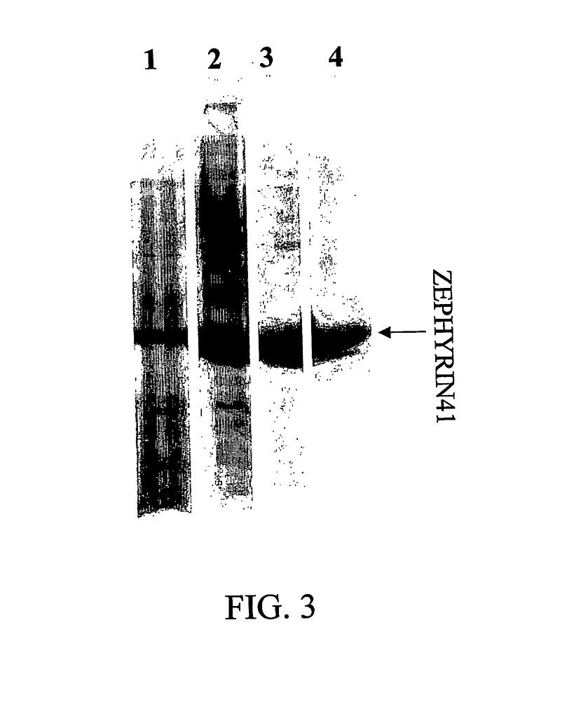

The C-linker of the cellulose binding recombinant protein (EXAMPLE 1; SEQ ID NO:3) was genetically mutated by point mutation as follows (FIG. 2): a) residues 7-8 were mutated to give flexible hinge linker (GS); b) residues 9-20 were mutated by the sequence LGIWGCSGKLIC (SEQ ID NO:7) which represent ZEPHYRIN41 antigenic epitope in HIV type 1 (Gnann J W, Science. 237:1346, 1987); and c) residues 21-34 were deleted. The resulting sequence was cloned into pET3d plasmid (Novagen WI, USA; FIG. 2A), and the resulting plasmid was used to transfect E. Coli strain BL21 (DE3). The transformed cells were grown on LB medium with the appropriate antibiotic. Upon IPTG induction, the recombinant fusion protein, also termed ZEPHYRIN41, was expressed as a soluble protein (FIG. 3, Lane 2).

The protein was purified from sonicated bacterial cells by two different schemes as described in the methods section (FIG. 3). Both purification schemes resulted in highly purified protein molecule (FIG. 3, lanes 2-4). The purification by affinity chromatography to cellulose matrix demonstrated that this protein molecule retained the original ability to bind specifically to its target matrix and to be eluted by conditions previously described in the literature. The molecular weight of the purified product was in agreement with the theoretical calculated value.

### Example 3

### Peptide Library Construction

E. Coli strains XL1 blue was used as a host cell during the library construction, strain BL21 (DE3) and the T7 RNA polymerase expression vector pET3d were used for the expression of soluble fusion proteins comprising a cellulose binding region encoded by SEQ ID NO:1 and a peptide. The sequence encoding the peptide library was synthesized by applying random mutagenesis on the 8 nucleic acids located at the C-terminus of SEQ ID NO:3 which is the C-terminus linker of SEQ ID NO:1. To avoid premature termination an NNB (B=C/T/G) degeneracy was used in order to exclude all stop codons. Amplification was performed using:

primer I-

(SEQ ID NO:8)

GAGATATATC ATGAGCGCTA ATACACCGGT ATCAGGC
primer II-

(SEQ ID NO:9)

TAGCAGGGAT CCTTAVNNVN NVNNVNNVNN VNNVNNVNNA
CTGCCTACAG GCTGTGTTGA TGG
template-
SEQ ID NO: 1 joined, in frame, with SEQ ID NO:3

The amplified PCR product was digested with BamHI and BspHI and was ligated to BamHI/NcoI digested pET3d (Novagen, Inc., Madison, Wis.). Chemically competent XL1 blue cells were transformed with 20 μl aliquots (10 ng). Transformed cells were grown overnight under appropriate conditions and plasmids were purified. Purified plasmids were used to transform competent BL21 cells. After transformation cells were plated on LB agar plate containing ampicillin (160 μg/ml) and were grown overnight. The peptide library was amplified by PCR.

The peptide library was expressed in E. Coli BL21 strain. 96 single colonies were randomly selected and removed into sterile 96-well plates, using sterile tips, where each well contained 100 μl LB medium enriched with ampicillin (100 μg/ml). Cells were grown under continuous agitation at 37° C. until about OD=1 at 600 nm and were then induced with IPTG (final concentration of 1 mM) and expression was carried on for 18 hr under continuous agitation at 16° C. Aliquot of SDS/NaOH (0.4%/80 nM) solution was added into every well and cell lysis was taking place. Cell lysate was then attached to a matrix of cellulose as described above.

### Example 4

### Immunoassay Assessment of the Recombinant Proteins

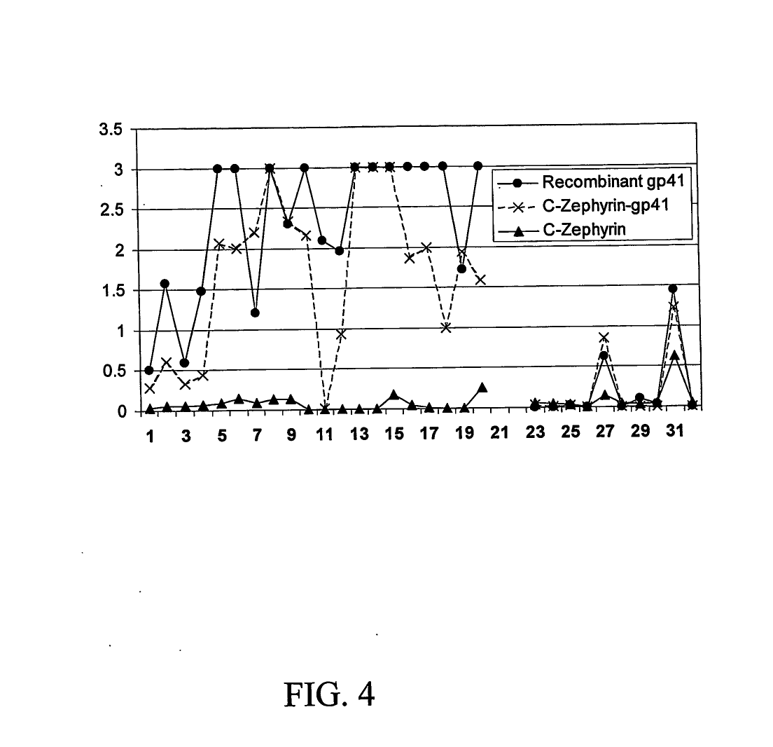

The sensitivity and specificity of purified ZEPHYRIN41 was tested in an immunoassay test with serum of HIV type 1 infected individuals (n=20; FIG. 4 patient Nos. 1-20) and with serum of healthy individuals (n=10; FIG. 4 patient Nos. 23-32). For this purpose micro-plate was coated, as described hereinabove, with the protein having the sequence SEQ ID NO:4, the recombinant mutated fusion protein (ZEPHYRIN41) and recombinant gp41 (see FIG. 3). Each sample of serum was diluted ×10⁵.

Antibodies against ZEPHYRIN41 and recombinant gp41 were detected in 19 of 20 and in 20 of 20 HIV type 1 infected individuals respectively, and in 2 of 10 for both molecules in healthy individuals. In contrast, the cellulose binding protein (SEQ ID NO:4) was not reactive with serum sample from HIV type 1 infected individuals but a single false positive result (1 of 10) was detected in the samples from healthy individuals (FIG. 4; sample #31). A single false negative result (1 of 10) was observed for ZEPHYRIN41 in HIV type 1 infected individual serum. Two false positive results were detected for the recombinant gp41 and one for ZEPHYRIN41 in the healthy individual serum (FIG. 4; samples #27 and #31).

The results for the HIV type 1 infected individuals were consistent with those obtained from a commercial kit regularly used in hospitals for HIV type 1 detection. These results clearly demonstrate the utility of ZEPHYRIN41 in term of sensitivity and specificity compared to the recombinant gp41 protein.

### Example 5

### Construction of Cellulose Binding Regions Containing Exogenous Peptides

The principle of modifying a cellulose binding region such that it further contains exogenous peptides is exemplified herein using a protein encoded by SEQ ID NO:1 modified at loop 5/6. The concept of a cellulose binding region containing an exogenous peptide has a great potential for measurements of protein-peptide interaction. Small peptides that are used for protein recognition tend to have limited affinities and specificities preliminary due to the absence of a 3D-structure. Thus, presentation of peptides within a defined structure may increase recognition and binding with high affinity of such peptides.

DNA primers with homology to the C terminus of SEQ ID NO:1 and with partial homology to the region of loop 5/6 within that sequence were synthesized:

terminal primer III:

(SEQ ID NO:11)

ccgcaccatg gcaaatacac cggtattca
terminal primer IV:

(SEQ ID NO:12)

tcgcggatcc ttatactaca ctgccaccgg g
loop 5/6 primer V:

(SEQ ID NO:13)

gcccgttgaa accgtgccgg tcacttttac aaatgttcct tt
loop 5/6 primer VI:

(SEQ ID NO:14)

gtgaccggca cggtttcaac gggcgacacc taccttgaaa ta

The primers for remodeling the loop 5/6 were designed to contain the following amino acid: VTGTVSTG (SEQ ID NO:15). Amplification of the remodeled region DNA via PCR was performed for 25 cycles with ExTaq polymerase (TAKARA BIO Inc., JAPAN). The PCR products were purified from agarose gel and used for a second amplification round with the N and C terminal primers. The PCR products of the second run were digested by NCO I/BamHI and ligated.

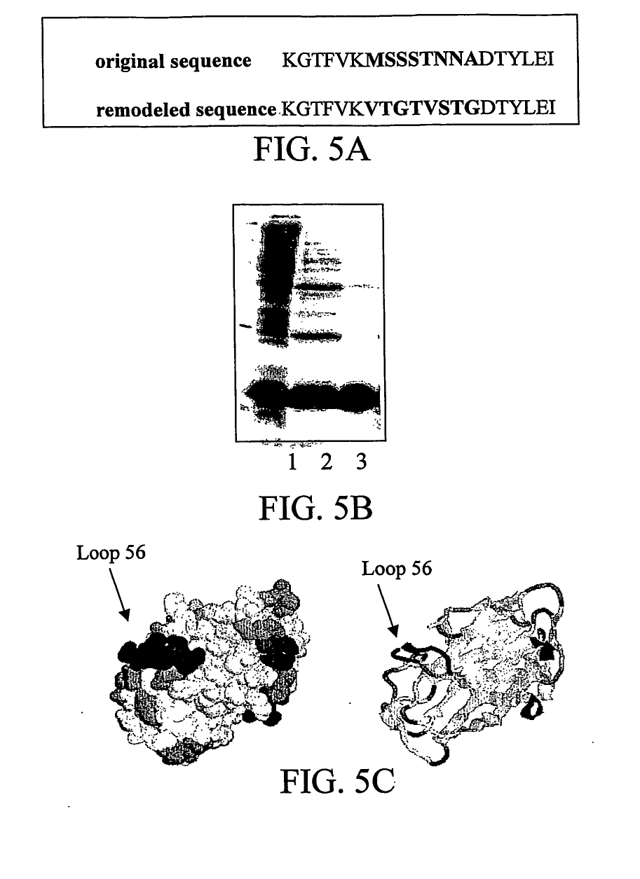

Loop 5/6 (LP5/6) within SEQ ID NO:4, is located between β-strand 5 and β-strand 6. In this example a random peptide of 8 amino-acids was introduced into this loop using molecular biology techniques. The original loop sequence MSSSTNNA (SEQ ID NO:16) was mutated to give the following sequence: VTGTVSTG (SEQ ID NO:15), which is completely incomparable with the original sequence. The overall structural organization of the original and the LP5/6-modified fragment is illustrated in FIG. 5A. The modified sequence was cloned into pET3d plasmid and the resulting plasmid was used for protein expression. Upon IPTG induction the mutated protein was expressed in a soluble form (FIG. 5B, lane 1). The stability of the LP5/6-mutated protein at 60° C. (FIG. 5B, lane 2) and its binding efficiency to cellulose (FIG. 5B, lane 3) were investigated. The LP5/6-mutated proteins were biotinylated and attached to cellulose-coated glass slides. Binding to cellulose and microarray compatibility were compared to those of the non-modified protein. The binding of the LP5/6-modified protein to cellulose coated glass slide was similar to that of the original non-modified protein. LP5/6-modified protein also maintained selective binding activity for cellulose and was easily detected using an antibody directed against SEQ ID NO:4.

Additional sites within the cellulose binding region derived from Clostridium Cellulovorans which may be modified while maintaining the high affinity of the modified region to cellulase substrates are:
1) loop between β-strand 7 and 8
2) β-strand 8 and β-strand 9
3) loop between β-strand 3 and 4
4) the residues that form second conserved site, located in a shallow groove on the other side of the cellulose-binding surface. The residues forming this shallow groove are characterized by sugar-binding sites of lectins and glycosyl hydrolases, as well as by antigen-binding sites of antibodies and MHC molecules.

### Example 6

### High Throughput Screening

### Materials and Methods

Cy3-labled rabbit anti-IgG Mouse (Jackson ImmunoResearch Laboratories).

### Preparation of a Chimeric Protein

Bacterial cells (100 ml of induced culture) from BL21 (DE3) were infected with the expression vector pET3d (FIG. 2), comprising an HTS peptide (GSSWSADLDK; SEQ ID NO:20) fused to the sequence encoding ZEPHYRIN. Cells were induced for 16 hr with 0.1 mM IPTG, centrifuged, the pellet was suspended in 10 ml and disrupted by sonication (40% amplitude, 5 cycles of 2 min each). Total cell extract was centrifuged at 15,000 g for 15 min at 4° C. and the soluble fraction was collected. The soluble fraction was incubated at 60° C. for 30 min followed by centrifugation at 15,000 g for 15 min at 4° C. The soluble fraction was collected and the purity level was evaluated by SDS-PAGE to obtain the chimeric protein ZEPHYRIN-HTS-PEPTIDE. The SDS-PAGE purified protein was divided into small aliquot and stored at −20° C.

### Preparation of a Library of Hybridoma

HTS peptide was injected into mice as known in the art to obtain various hybridoma. The various hybridoma clones were cultured in 96-well plates and the supernatant of each well was collected for the high throughput-screening assay.

### High-Throughput Screening Assay

Aliquots (5 ml per well) of the chimeric protein comprising a cellulose binding region fused to an HTS peptide, namely ZEPHYRIN-HTS-PEPTIDE, were dispensed into 96-well plates. Aliquots of the various hybridoma supernatants were added to the 96-well plates such that each well contained a supernatant from a different Hybridoma clone. The 96-well plates were incubated for 60 min at room temperature under continuous agitation, in order to allow the chimeric proteins to contact the hybridoma supernatants. Aliquots from each well were then printed, in duplicates, on cellulose-coated slides as describe above. In addition, the following negative control samples were printed on each cellulose-coated slide: (1) hybridoma supernatant that was not incubated with a chimeric protein, (2) BSA and (3) a chimeric protein. The printed microarrays were blocked by incubating the slides with 0.5% (wt/vol) BSA/PBS at room-temperature for 20 min. Slides were then incubated at room temperature with a diluted (1:1000) Cy3-labled rabbit anti-IgG Mouse for 1 hr. Slides were then washed five times with PBS with 0.1% (vol/vol) Tween 20, air-dried and scanned for fluorescence signals using a ScanArray Lite scanner (Packard BioChip Technologies).

Results

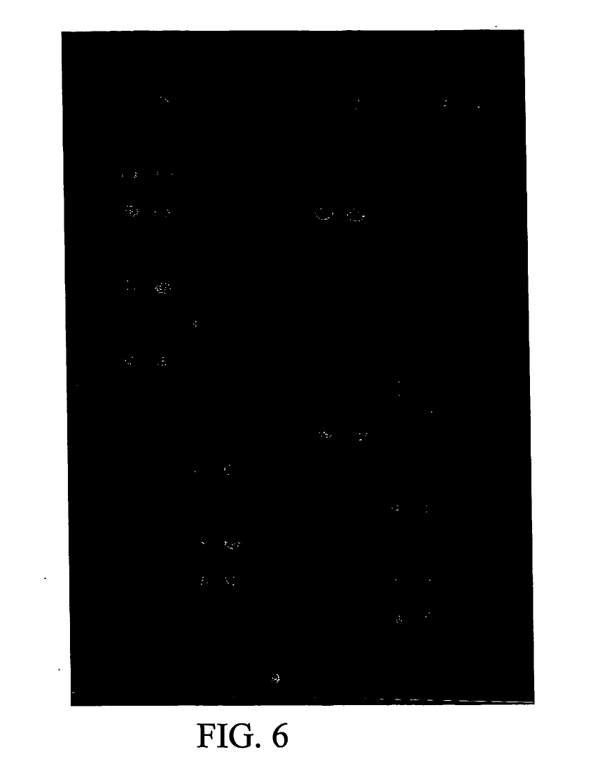

182 hybridoma samples were printed onto 182 loci in the microarray. Interactions between antibodies against HTS-PEPTIDE and hybridoma samples were detected, with high certainty, in 17 loci (Table 1; FIG. 6). Other positive loci were also detected though with a lower certainty.

The results were compared with the results obtained from a standard immunoassay. In that assay the antigenic peptide was chemically synthesized and conjugated to BSA in order to enable binding of the peptide to an ELISA plate.

The results obtained from positive hybridoma samples in the microarray assay were correlated with those obtained from a conventional ELISA screening. The comparison confirmed the results obtained from the microarray assay (Table 1). The results clearly demonstrate that the microarrays of the invention are suitable for high throughput screening (HTS).

TABLE 1
Hybridoma No.

| HTS-based microarray | | Sample re-tested |
|---|---|---|
| assay | ELISA assay | by ELISA assay |
| 26 | 26 | |
| 28 | — | |
| 35 | — | |
| 36 | — | |
| 68 | — | |
| 116 | — | |
| 125 | — | |
| 158 | — | |
| — | 184 | |
| — | 186 | |
| 189 | — | 189 |
| 191 | — | |
| 193 | — | |
| 197 | — | 197 |
| 208 | — | |
| 223 | — | |
| — | 227 | |
| — | 237 | |
| 263 | 263 | |
| — | 264 | |
| 265 | 265 | |
| 270 | — | |

### Example 7

### Serodiagnosis of HIV Type 1 in Microarray Format—Model for Peptide Antibody Interaction

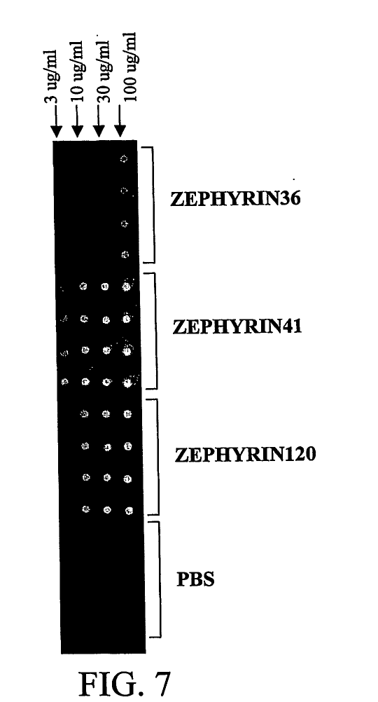

Antigen-peptide microarray for serodiagnosis of HIV type 1 and type 2 was prepared using the following recombinant proteins of the invention: ZEPHYRIN36 (for HIV type 2 only), ZEPHYRIN41 and ZEPHYRIN120 (for HIV type 1 and 2). The plasmid construction, expression and purification of ZEPHYRIN36 and ZEPHYRIN120 as was described above for ZEPHYRIN41 (Example 2). The type of microarray described herein allows simultaneous detection of both antibodies directed against HIV type 1 and antibodies directed against HIV type 2. The recombinant proteins were fabricated in serial dilutions on cellulose-coated glass slide. In order to identify the specific human IgG that binds to the fabricated molecules, slides were incubated with Cy3 Goat anti-human antibody. Fluorescence measurement of the microarray incubated with HIV type 1 infected individual serum (FIG. 7) clearly indicated positive interaction with ZEPHYRIN41 and ZEPHYRIN120 molecules for a wide range of concentrations (3-100 μg/ml) and for ZEPHYRIN36 concentration of 100 μg/ml. The results for the HIV type 1 infected individuals were consistent with those obtained from a commercial kit regularly used in hospitals for HIV type 1 detection.

### Example 8

### Direct and Indirect Detection

(i) Direct Detection with Cy5 Dye

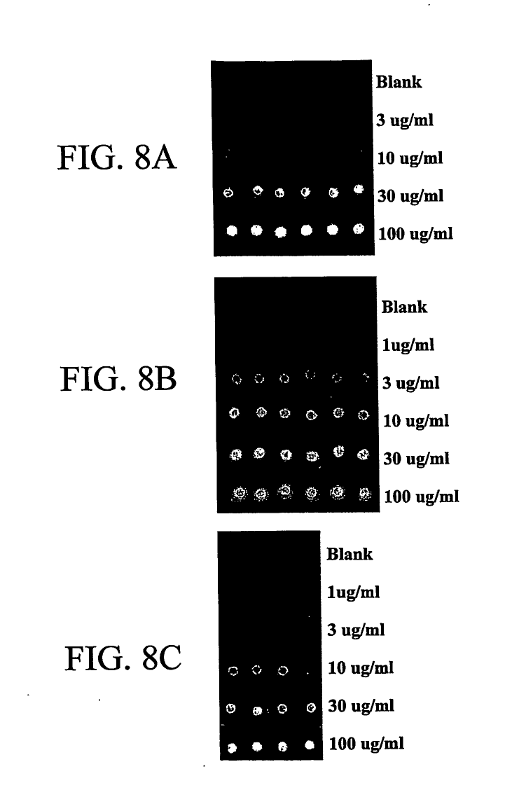

The recombinant protein comprising the cellulose binding region of SEQ ID NO:4 was tagged with Cy5 mono-reactive Dye Pack (Pharmacia biosciences; coupling through amine residue of lysine) prior to the fabrication as described hereinabove. The fabrication was followed by an extensive washing step and then the coated slide was blocked with 2% BSA (ICN, CA, USA) solution for 1 hr at room temperature. The washing and blocking steps were performed in complete darkness. Finally, the slide was analyzed using a microarray scanner as described hereinabove. FIG. 8A shows a representative response obtained by direct labeling of the recombinant protein containing the cellulose binding region. The image shows that direct labeling does not impair the adsorption of the labeled molecule to cellulase substrate. This method enabled the detection of low peptide concentration, 6 picogram protein per microarray spot.

(ii) Indirect Detection with Biotin-Streptavidin System

The recombinant protein comprising the cellulose binding region of SEQ ID NO:4 was labeled with Biotin employing conjugation through amine residue of lysine (Sigma Chemical Co., MO, USA), fabricated onto cellulose coated glass slide, and detected using Streptavidin Alexa fluor® 546 (Molecular Probes, OR, USA; FIG. 8B) as described hereinabove. Labeling of the recombinant protein molecule through amine residues did not impair its ability to bind cellulose. This method presented similar levels of detection as describe before (6 picogram protein per microarray spot).

(iii) Indirect Detection

The recombinant protein comprising the cellulose binding region of SEQ ID NO:4 was detected using Cy5 tagged rabbit antibody directed against the protein (FIG. 8C). The color intensity obtained from the Cy5 tag increased in line with the increase of recombinant protein concentration. This indirect quality control test enabled the detection of about 2 picogram of recombinant protein molecule per spot in the microarray. The fluorescence resulting from the non-biotinylated recombinant protein and from PBS in the second and third detection assays was negligible, indicating a very low degree of non-specificity.

### Example 9

### Fabrication of the Microarray with Non-purified Probes/Molecules

Microarray fabrication of a protein or a peptide by the technologies known in the art requires purification of these molecules prior to the fabrication process. This prerequisite is definitely impractical for the fabrication of libraries containing thousands of proteins.

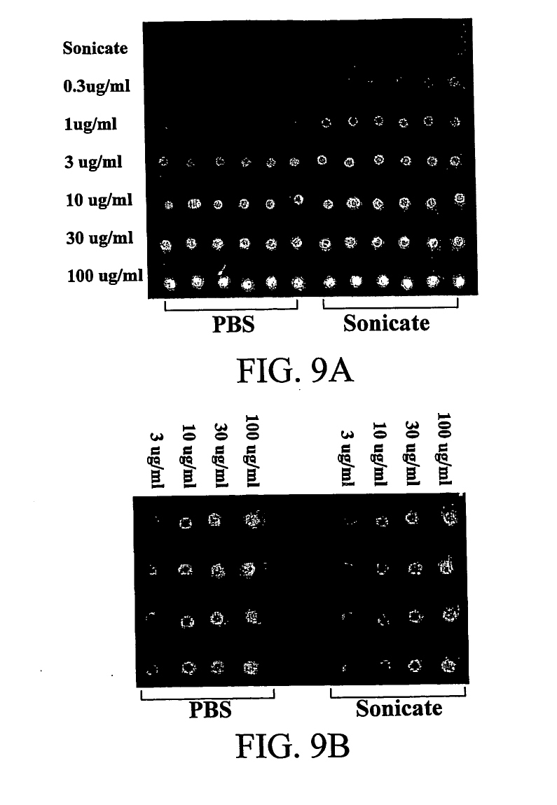

A microarray, fabricated on cellulose-coated glass slide, was constructed using a recombinant protein containing cellulose binding region of SEQ ID NO:4 diluted with E. Coli extract (FIG. 9A; Right panel) or PBS (FIG. 9A; Left panel). The fabrication, blocking, and analyses were performed as described hereinabove. Immobilization of the recombinant protein to cellulose coated glass slide was evaluated using the fluorescence signals generated when Cy5 rabbit antibody against the recombinant protein was introduced to the microarray (FIG. 9A). Relatively similar extent of binding to cellulose was observed for both the purified and the non-purified recombinant protein comprising the cellulose binding region having the sequence of SEQ ID NO:4. At low concentrations (0.3-3 μg/ml) binding of non-purified recombinant protein was higher than binding of the purified recombinant protein. The increased sensitivity which was demonstrated at very low protein concentrations may be interpreted as follows. The purified biotinylated-protein demonstrated low levels of non-specific binding to the solid support which thus became significant only at low concentrations of the protein. However, the E. Coli cell extract that was present in the non-purified biotinylated-protein samples blocked the solid support in a way that minimized the non-specific binding.

The results here indicate that binding of proteins comprising the cellulose binding region of SEQ ID NO:4 or the cellulose binding region of SEQ ID NO:4 flanked by at least one of the native linkers (i.e. SEQ ID NO:5 and/or SEQ ID NO:6) to cellulose, is not affected by the presence of unrelated proteins, DNA and other small molecules.

Efficient binding of non-purified recombinant protein was also shown in a microarray based on recombinant proteins comprising the cellulose binding region of SEQ ID NO:4 as well as in a microarray based on recombinant proteins comprising the cellulose binding region of SEQ ID NO:4 flanked by SEQ ID NO:6, labeled with His₆-tag (FIG. 9B). Binding was assessed using Cy5 mouse anti his₆-Tag antibody (Serotec Ltd., Oxford, UK). Again, the presence of crude E. Coli extract did not impair the extent of binding of the recombinant protein labeled with His₆-tag to cellulose (FIG. 9B).

Fluorescence of E. Coli extract alone, using both detection methods described in the present example (FIGS. 9A and 9B), gave no signal. This result emphasized the finding that binding of non-purified recombinant protein comprising the cellulose binding region of SEQ ID NO:4 as well as in a microarray based on recombinant proteins comprising the cellulose binding region of SEQ ID NO:4 flanked by SEQ ID NO:6, in E. Coli extract to cellulose, is highly specific and that the cellulose matrix remains inert to the nonspecific adsorption of various molecules present in the crude extract. The results presented in this example clearly demonstrate the superiority of the libraries and methods of the present invention for construction of peptide and protein libraries and for high throughput applications, over the exiting technologies.

### Example 10

### Microarray Application for a Protein and a Small Ligand Interaction

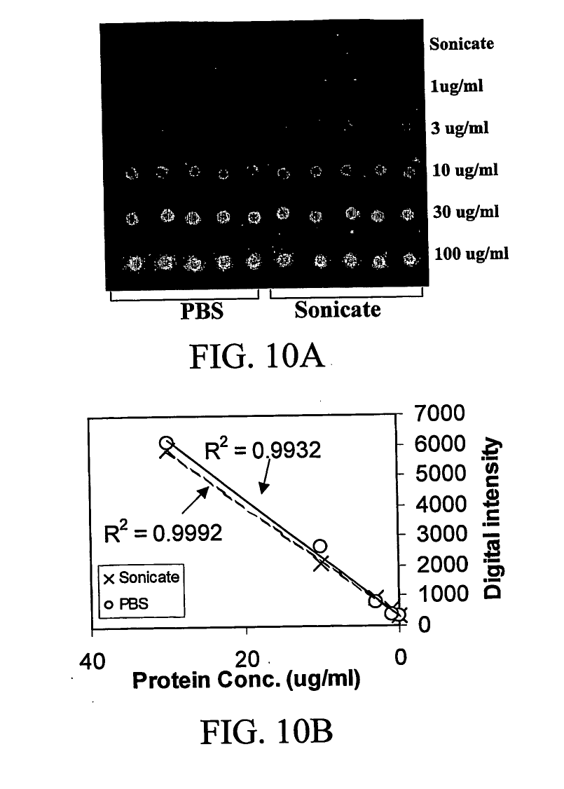

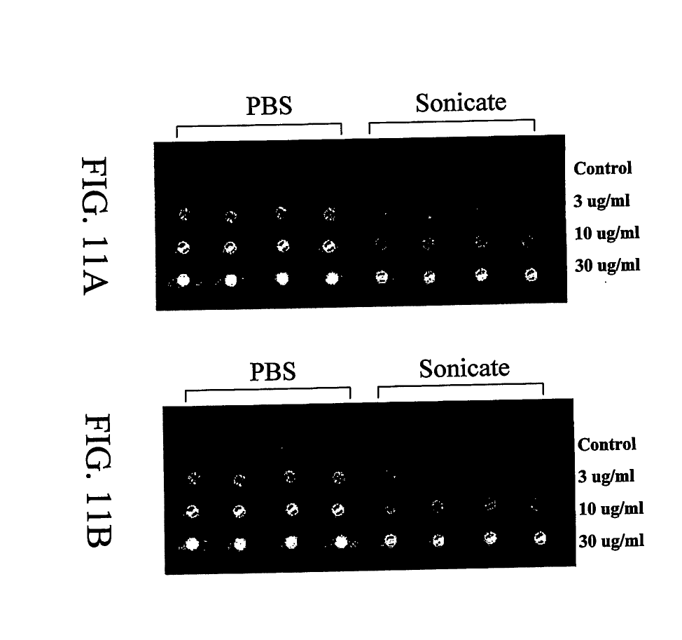

The interaction of a small ligand and a protein was tested. For this purpose biotinylated recombinant protein comprising the cellulose binding region of SEQ ID NO:4 was diluted with PBS to concentrations of 1, 3, 10, 30 and 100 μg/ml. These protein samples were fabricated in six replicates and the interaction with Streptavidin Alexa flour® 546 was measured (FIG. 10A). Linear regression analysis was applied on the photo-multiplier counts versus the concentration of the biotinylated recombinant protein fabricated on the cellulose coated glass slide (FIG. 10B). The correlation coefficient (R²) calculated from this analysis was close to unity. In most samples a coefficient of variation (CV) for each concentration was less than 15%.

### Example 11

### Microarray Dual Application: Detection and Interaction

It was demonstrated that applying the libraries of the invention enables quantitative and qualitative detection by direct and indirect labeling methods (Example 7). It therefore became of an interest to determine the ability to detect a molecule and simultaneously to perform an immunoassay test by the same molecule using the libraries of the invention. For this purpose a microarray of ZEPHYRIN41 was fabricated onto a cellulose-coated glass slide. Samples of sera from HIV type 1 infected individuals were applied onto the microarray, following incubation with Cy3 goat anti-human IgG (FIG. 11A) and Cy5 rabbit directed against the protein of SEQ ID NO:4 (FIG. 11B). The simultaneous incubation step was followed by washing and scanning steps. This example established for the first time a new strategy for simultaneous measurement with no mutual interference of two different antibodies for two different epitopes in one molecule.

### Example 12

### Cell Adhesion Assay Using C-zephyrin-α4

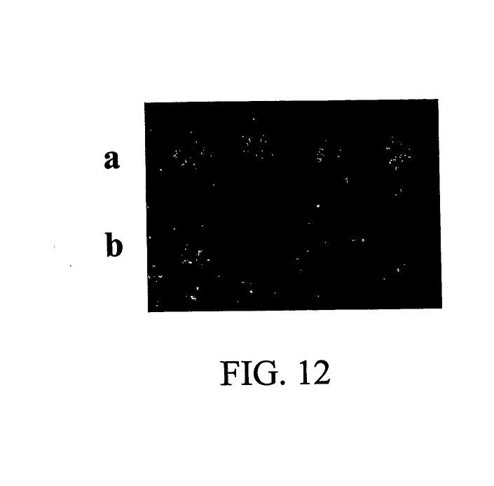

The interaction of cell surface receptor and small ligand such as peptide was used as a model system to demonstrate the compatibility of the libraries and methods of the present invention to cell adhesion assay. The model of interaction chosen for this purpose was α4β1-CS1-interaction model. α4β1 is an integrin expressed by several types of adherent cells and can mediate cell matrix contact trough the known ligand fibronectin. The known binding region sites within this protein in the CS1 peptide. Accordingly, the C-linker (SEQ ID NO:6) of the protein of SEQ ID NO:4 was genetically mutated by point mutation to display the CS1 peptide (EILDVPST; SEQ ID NO:10). The resulting protein, named herein ZEPHYRIN-CS1 and the original protein were used to fabricate cellulose-coated glass slide. Jurkat cells expressing the α4β1 integrin which were labeled (by fluorescence) were then introduced with the microarray and allowed to interact with the ZEPHYRIN-CS1 for 1 hr at room temperature. The slides were washed extensively and the interaction was scanned by the microarray scanner (FIG. 12). As anticipated, only spots containing the ZEPHYRIN-CS1 were clearly visible, indicating that the labeled cells adsorbed to this molecule, by virtue of its selective affinity to the α4β1 integrin expressed on the cells. The binding was found to be proportional to the concentration of ZEPHYRIN-CS1. Negative control spots containing the original protein (SEQ ID NO:4) at the highest array concentration, yielded no detectable signal.

### Example 13

### Stability of the Microarrays Under Extreme Conditions

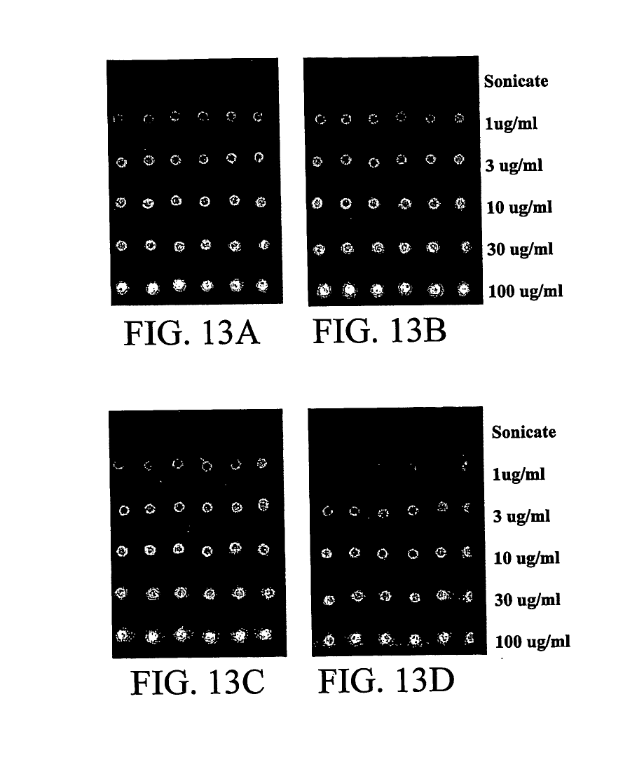

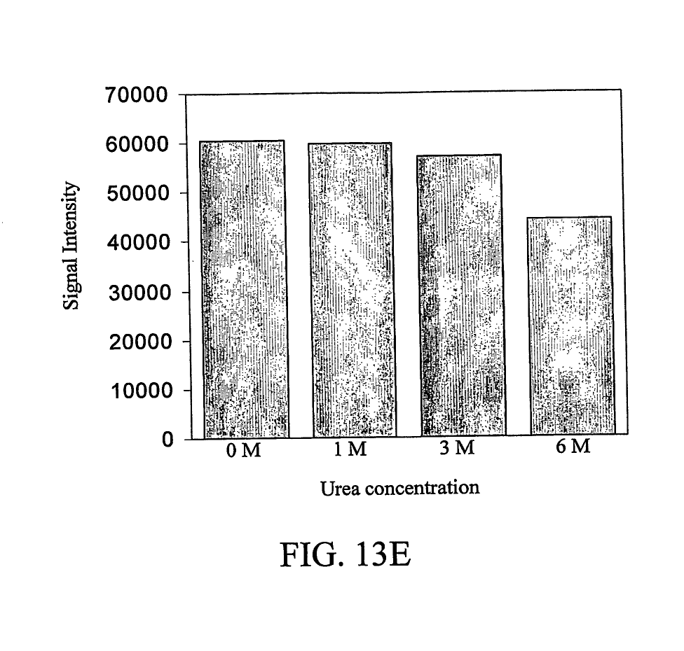

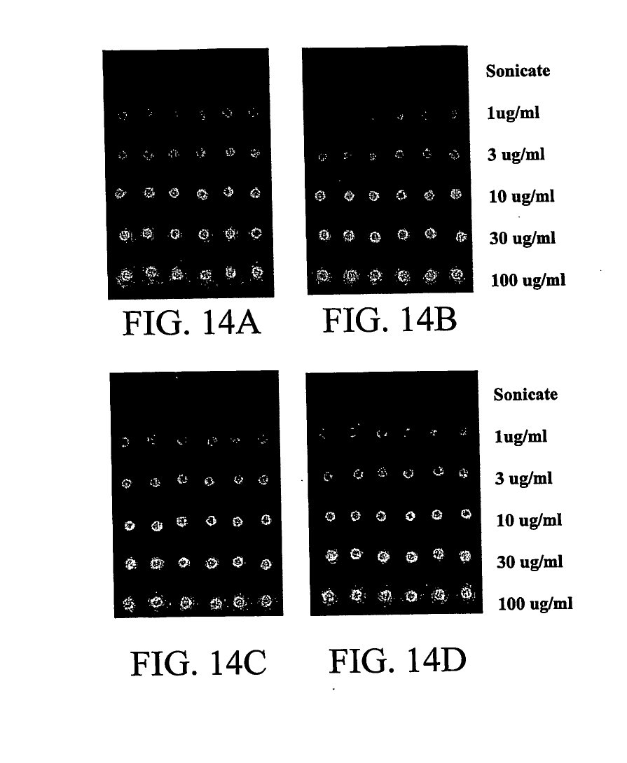

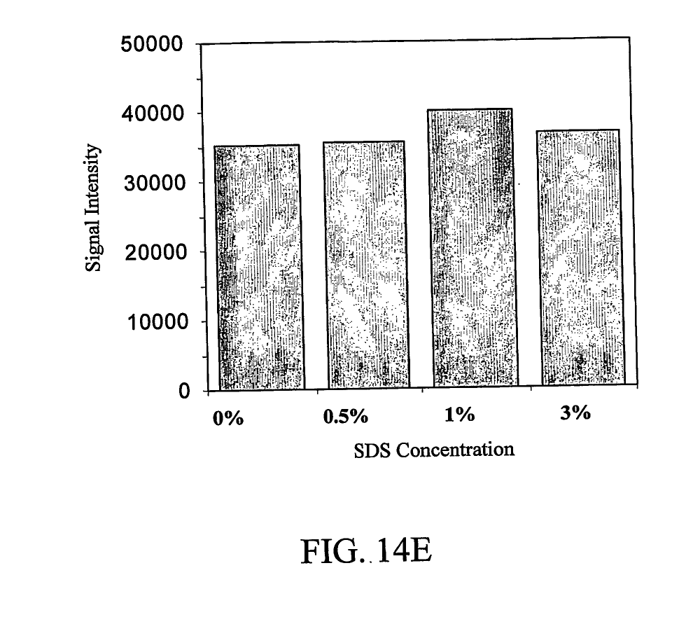

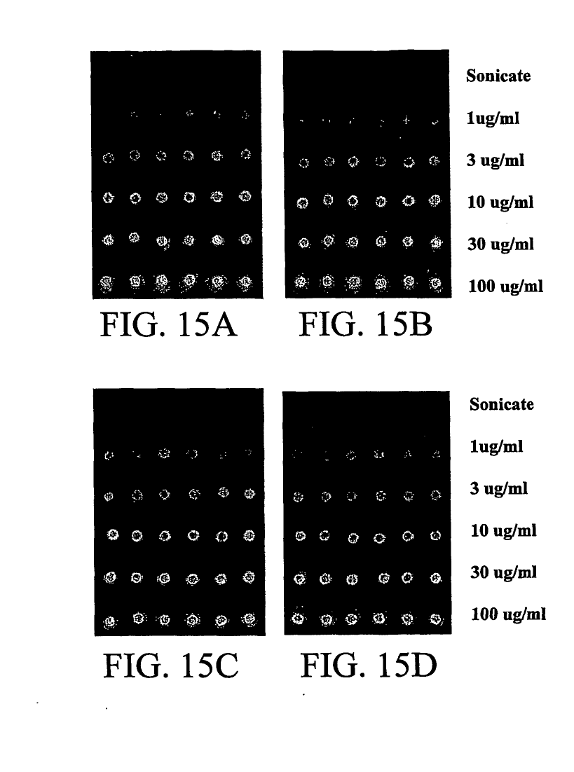

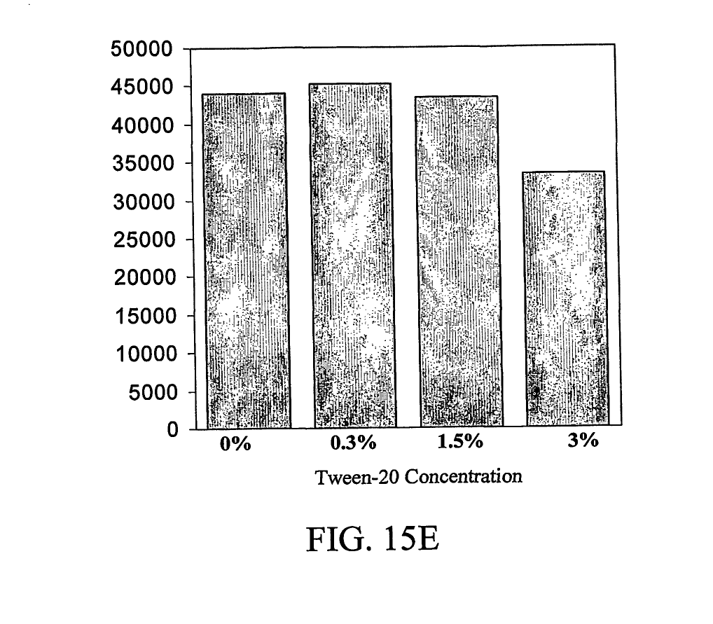

Ligand characterization may require solubilization, stabilization, purification and activation under harsh conditions using detergents such as SDS, Tween-20 and chaotropic agents such as urea. To demonstrate the capability of the microarrays of the present invention to perform under extreme conditions, proteins having the amino acid sequence of SEQ ID NO:4 chemically bound to biotin were attached to cellulose coated glass slides and were incubated for 1 hr at various concentrations of urea (FIG. 13), SDS (FIG. 14) and Tween-20 (FIG. 15). Slides were then incubated with streptavidin alexa fluor 546® and the residual amount of immobilized protein was measured as shown in FIG. 13E (urea), FIG. 14E (SDS) and FIG. 15E (Tween 20). Binding of the proteins to cellulose was not affected by any of the tested agents not even when extreme concentrations were used (e.g. 6 M urea, 3% SDS). The results demonstrate the high stability of the microarrays of the present invention.

### Example 14

### DNA Microarrays

A microarray of oligonucleotides conjugated to Cysteine 55 of proteins comprising SEQ ID NO:4 (the only cysteine in SEQ ID NO:4) was used. Coupling was carried through the free sulfhydryl group of Cysteine 55. The conjugates were prepared as follows: aliquots of 10 μl (2 mg/ml) of 24-mer 5′ end amino modified oligonucleotide were mixed with 2 μl of 1M NaHCO₃ pH8.1 and 8 μl (0.7 mg/ml) Sulfo-SMCC. The mixture allowed to react at room temperature for 1 hr. The activated-oligonucleotides were then mixed with 16 μl (6 mg/ml) of proteins having SEQ ID NO:4 and maleimide at the molar ratio of 4:1 activated-oligonucleotide to protein following 4 hr incubation at room temperature. Conjugates were stored at 4° C.

Conjugates and non-conjugated proteins (SEQ ID NO:4) were attached to cellulose coated glass slides. Following pre-hybridization step the cellulose-coated slides were incubated with complementary Cy5 oligonucleotide probe, washed and scanned.

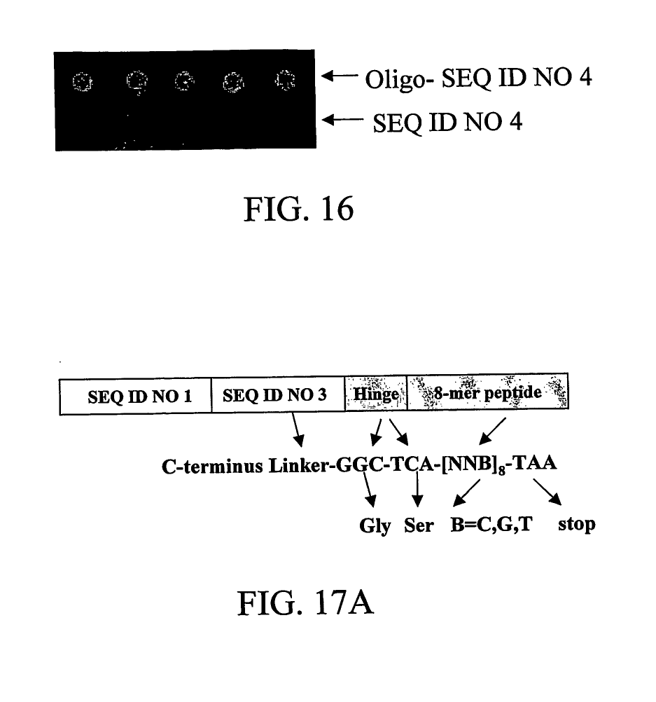

The results, as shown in FIG. 16, clearly indicate the specific binding of Cy5 oligonucleotide probe to its associated molecule, i.e. to proteins comprising a cellulose binding region (SEQ ID NO:4) coupled through the free sulfhydryl group of cysteine 55 to an oligonucleotide. Non-conjugated proteins which contained only SEQ ID NO:4 did not produce fluorescence signals, demonstrating that the technology has both good signal-to-noise ratio and high specificity. The interaction of an array containing non-conjugated 24-mer amino modified oligonucleotides with Cy5 probe was non-detectable. This example establishes a new strategy for DNA microarrays based on cellulose binding proteins with improved presentation and orientation of the oligonucleotides suitable for DNA-DNA interaction.

### Example 15

### Microarrays of Peptide Library

Peptide microarrays enable precise characterization of molecular recognition events at the amino acid level. In addition, information obtained from peptide-microarrays can be used for measuring enzymatic activity such as protease activity, kinases and isomerases, and may be also used for cell adhesion assay. Peptides library are collections of very large numbers of random recombinant peptides, in which almost all possible combinations of the amino-acids used are represented. Numerous techniques for peptide library synthesis are known. Yet, the ability to fabricate pre-synthesized or in-situ synthesized peptides on the surface of glass-slide is limited to hundreds of peptides per slide. The following example demonstrates recombinant display of random peptide library on cellulose-coated glass slide using the microarrays of the invention.

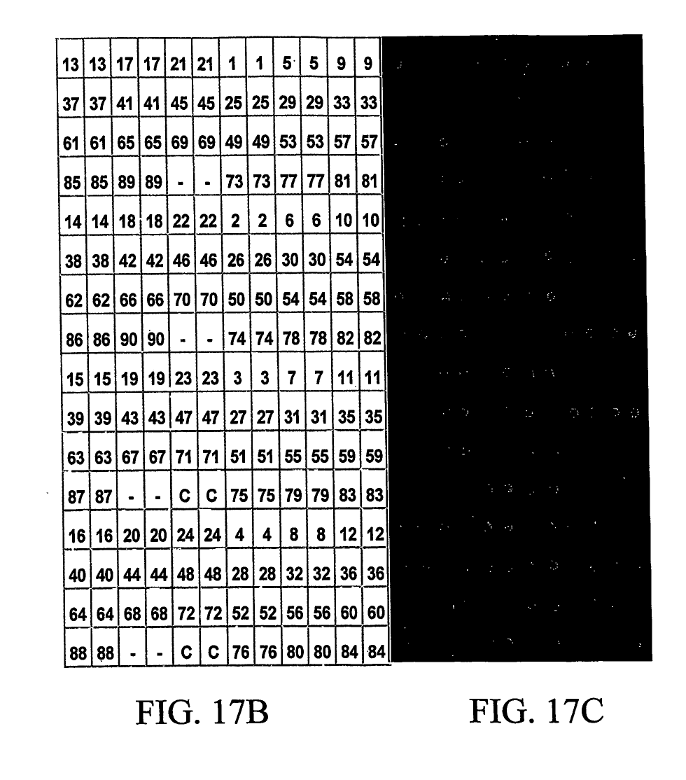

A combinatorial library was constructed at the C-terminus linker (SEQ ID NO:3) of SEQ ID NO:4 (FIG. 17A). The randomization procedure resulted in a display of random peptides of 8 amino-acids. Plasmids containing the DNA sequence encoding SEQ ID NO:1 and the mutated SEQ ID NO:3 in the same reading frame were used to transform purified E. Coli strain BL21. The transformed cells were plated on LB agar plate for overnight incubation, single colonies (96 colonies) were then randomly selected and transferred into 96-well plate containing 100 μl of medium. Cells were induced using IPTG and following overnight incubation cells were lyzed using SDS/NaOH solution and cell lysate was fabricated in duplicates (FIGS. 17B-C). The peptide library was detected using Cy5 labeled rabbit anti SEQ ID NO:1 (FIG. 17C). Most colonies were readily detected by the labeled antibody. The signal intensities was relatively uniform indicating uniform expression level for the positive colonies that were grown under identical conditions in the 96-well plate. In addition, the harsh condition of solubilization of the cells in the 96-well plate did not affected the binding of the proteins comprising the peptide library to the cellulose matrix. Sequence analysis of the clones showed that no biases were found using the library construction.

### Example 16

### Microarray Application for a Protein-Protein Interaction

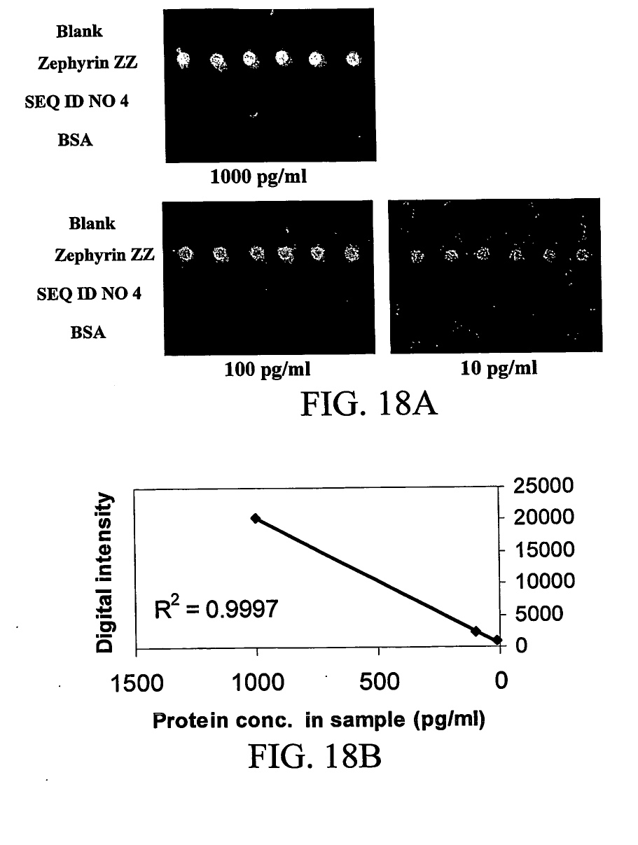

This example demonstrates the versatility of the libraries and methods of the present invention towards the field of protein-protein interaction. A microarray encompassing chimeric proteins, each protein comprising the amino acid sequence as set forth in SEQ ID NO:4 fused to ZZ domain (two identical domains of protein A molecule) also termed hereinafter ZEPHYRIN-ZZ was fabricated onto cellulose coated glass slides. The spots consisted of 30 μg/ml of ZEPHYRIN-ZZ were allowed to react with 10, 100 and 1000 pg/ml of Cy5-rabbit IgG. FIG. 18A shows a set of 3 microarray fluorescence images, which were taken after 2-hr incubation of the cellulose-coated slides with the Cy5-rabbit IgG. The fluorescence signals increased with increasing concentrations of the antibody, whereas the intensities observed for negative control samples (SEQ ID NO:4) remained negligible. FIG. 18B shows the dose-response curves for the three concentrations (10, 100, 1000 pg/ml). Under the applied conditions, the dose-response curve was linear with a correlation coefficient of 0.999.

### Example 17

### Microarrays of Binary Ligand Display

A microarray of binary ligand display comprises: peptide library (as described in Example 15) and heparin molecules. The construction of the microarray is based on three steps: (a) amidation of heparin; (b) production of maleimide activated heparin; and (c) coupling the heparin to the peptide library.

In the first step, amine group is introduced into the reducing end of the heparin molecule. For this purpose, heparin in phosphate buffer is mixed with adipic dihydrazide and allowed to interact for 5 days at 55° C. The amine-heparin is extensively dialyzed against PBS.

In the second step, the terminal amine-heparin is allowed to interact for 2 hr at room temperature with sulfosuccinnimidyl 4-(N-maleimidomethyl)-cyclohexane-1carboxylate). This water-soluble cross-linker is reacted with the amine group of the heparin molecule to give maleimide activated heparin molecule.

In the third step, the maleimide activated heparin is used for coupling the heparin to a peptide library or alternatively to protein fused to SEQ ID NO:4. The peptide library is a library of proteins comprising cellulose binding region and further containing a peptide inserted within the region or the peptide library is a library of fusion proteins wherein a first protein comprises a cellulose binding region and fused to a peptide. Prior to the interaction between the activated heparin and the peptide library, the library is attached onto a cellulose coated solid support. The coupling is carried through the free sulfhydryl group (Cysteine 55).

The screening step include labeling FGF with Cy dye such as Cy3 or Cy5. The labeled FGF is then added into BSA/PBS buffer and allowed to react with the fabricated microarray. After 1 hr incubation the cellulose-coated slide is washed extensively and signal is detected.

### Example 18

### Microarray Stability in the Presence of a Lysis Buffer

In order to obtain maximal efficiency of the peptide-library microarray the expression system of the linear peptide-library step has to be compatible with the high throughput requirement. This requirement was examined using the microarrays of the present invention and a commercial lysis buffer consisting of NaOH and SDS, both of which are considered destructive agents but are also highly efficient and amenable for high throughput applications.

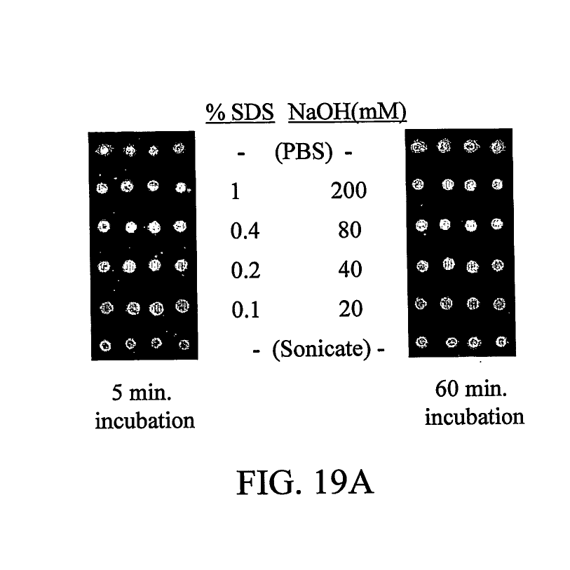

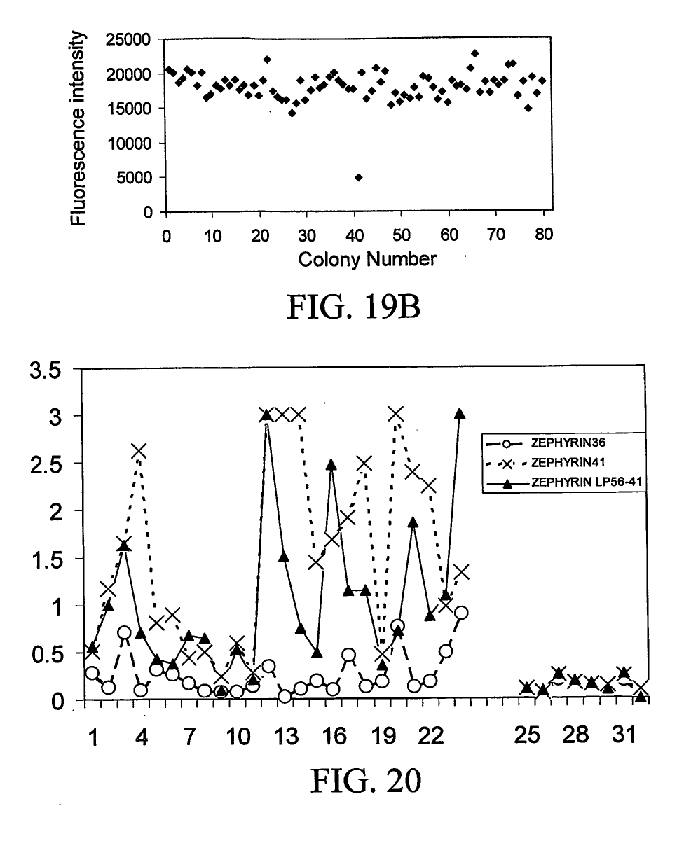

SEQ ID NO:4 biotinylated at the C-terminus was dissolved and incubated in lysis buffer or diluted lysis buffer for 5 or 60 min, following deposition on a cellulose-coated slide. The immobilized samples were detected by fluorescent streptavidin (FIG. 19A). The fluorescence signals generated from binding the biotinylated molecules to the cellulose membrane were not affected by the incubation time in the lysis buffer or by the concentration of the lysis buffer. Nevertheless, complete lysis of cells was clearly evident for all concentrations of lysis buffer.

Next, E. Coli were cultured in sterile 96-well plates containing 100-μl/well of growth medium and inoculated with 5-μl suspensions of single colonies expressing SEQ ID NO:4-linked to linear peptides of unknown sequence. The growth rate in the wells was monitored optically, using an ELISA reader equipped with a 600 nm filter. Upon reaching an OD 1, IPTG was added, and the induction was allowed continue for an additional 18 hr at 16° C. The cells were then lyzed by addition of 10-μl lysis buffer. Samples from each well (n=80) were fabricated in duplicates on cellulose-coated slides and visualized by Cy5-rabbit-anti-SEQ ID NO:4). The expression level and the reproducibility were then estimated (FIG. 19B). Most of the wells generated positive and measurable signals after labeling the slide with the fluorescent antibody. High reproducibility scores were obtained (FIG. 18C) with an average signal intensity of 18,000 a.u. (arbitrary units) and standard deviation of 2,222 a.u.

### Example 19

### Construction of Cellulose Binding Regions Containing Exogenous PKA and gp41 Peptides Therein

The principle of modifying a cellulose binding region such as it further contains exogenous peptides therein is exemplified in the present example using a protein encoded by SEQ ID NO:1 modified at loop 5/6. Table 2 summarizes the original sequence for loop 5/6 and the mutated sequences used in this example.

TABLE 2

| | Sequence/ | |
|---|---|---|
| Properties | SEQ ID NO. | COMMENTS |
| Loop 5/6 | MSSSTNNA/17 | a fragment of |
| | | SEQ ID NO:1 |
| Loop 5/6 modified for | LRRASLG/18 | |
| substrate for PKA | | |
| gp41 antigenic epitope | GCSGKLIC/19 | |
| in HIV type 1 | | |

DNA primers having a homology to the C and the N termini of SEQ ID NO:1 and a partial homology to the region of loop 5/6 (in order to introduced the mutations) within the sequence were synthesized.

### Primers Used for Insertion of PKA:

Terminal I:

(SEQ ID NO:21)

tggaccatgg caaatacacc ggtatca
Terminal II:

(SEQ ID NO:22)

tagcagccgg atccttatac tacactgcca ccggg
Loop 5/6 III:

(SEQ ID NO:23)

ttgcgtcgcg catctttggg cgacacctac cttgaaata
Loop 5/6 IV:

(SEQ ID NO:24)

gcccaaagat gcgcgacgca acatttttac aaatgttcc

### Primers Used for Insertion of gp41 Antigenic Epitope in HIV Type 1:

Terminal I:

(SEQ ID NO:25)

tggaccatgg caaatacacc ggtatca
Terminal II:

(SEQ ID NO:26)

tagcagccgg atccttatac tacactgcca ccggg
Loop 5/6 III:

(SEQ ID NO:27)

ggctgcagcg gcaaattgat ctgcgacacc taccttgaaa ta
Loop 5/6 IV:

(SEQ ID NO:28)

gcagatcaat ttgccgctgc agccttttac aaatgttcct tt

The primers for rational remodeling the loop 5/6 were designed to contain the following amino acid: LRRASLG (SEQ ID NO:18) and GCSGKLIC (SEQ ID NO:19). A representative amplification for obtaining a cellulose binding protein baring a peptide comprised within the amino acid sequence of the PKA is initiated by two PCR reactions: (1) using the primers of SEQ ID NOS:21 and 23; and (2) using the primers of SEQ ID NOS:22 and 24. Amplification of the remodeled region DNA via PCR was performed for 25 cycles with ExTaq™ polymerase (TAKARA, BIO Inc. JAPAN). The PCR products of the two PCR reactions were purified from agarose gel and used for a second amplification round, such that the only polynucleotides in the second round were the products of the first two PCR reactions. In other words, the products of the first two PCR reactions were used for priming each other to finally obtain the final products which is a polynucleotide encoding the CBD of SEQ ID NO:4 wherein SEQ ID NO:18 is inserted therein within loop 5/6. The PCR product of the second run was digested by NcoI/BamHI and ligated.

Using procedures as described above, two rationally designed peptides of 7 and 8 amino-acids were introduced into loop 5/6 using molecular biology techniques known in the art. The original loop sequence MSSSTNNA (SEQ ID NO:16, which is a fragment of SEQ ID NO:4) was mutated to give the following sequence: LRRASLG (SEQ ID NO:18; Table 2) and GCSGKLIC (SEQ ID NO:19; Table 2), which are completely incomparable with the original sequence. The modified sequences were cloned into pET3d plasmid and the resulting plasmids were used for protein expression. The recombinant protein comprising the CBD of SEQ ID NO:4, with SEQ ID NO:19 inserted therein (within loop 5/6) is termed hereinafter, ZEPHYRIN LP56-41.

Upon IPTG induction the mutated proteins were expressed in a soluble form. The binding efficiency of the two mutated proteins to cellulose was investigated. The results indicated that the modified molecules, mutated at loop 5/6, maintained their original cellulose-binding properties implying that modification of loop 5/6 does not affect the structural integrity of the unmodified molecule of SEQ ID NO:4.

### Example 20

### Immunoassay Assessment of Recombinant Proteins Comprising gp41 Antigenic Epitope

The sensitivity and specificity of purified ZEPHYRIN41 and ZEPHYRIN LP56-41 (see the above example) were tested in an immunoassay with sera of HIV type 1 infected individuals (n=24; patient Nos. 1-24) and healthy individuals (n=8; patient Nos. 25-32). For this purpose a micro-plate was coated with the following recombinant proteins: (a) ZEPHYRIN36 fusion protein, which represents the gp36 antigenic epitope of HIV type 2; (b) ZEPHYRIN41 fusion protein, representing gp41 antigenic epitope of HIV type 1 (SEQ ID NO:19); and (c) ZEPHYRIN LP56-41, a cellulose binding regions having a modified amino acid sequence of SEQ ID NO:4, wherein the gp41 antigenic epitope of HIV type 1 (SEQ ID NO:19) is inserted within loop 5/6.

All sera samples were diluted ×10⁵. The results of the immunoassay are shown in FIG. 19. Antibodies against ZEPHYRIN41 and ZEPHYRIN LP56-41 were detected in most (24/24 for ZEPHYRIN41 and 22/24 for ZEPHYRIN LP56-41) HIV type 1 infected individuals and in none of the healthy individuals (0/8). In contrast, the recombinant mutated fusion protein ZEPHYRIN36, presenting the gp36 antigenic epitope in HIV type 2, was reactive in 4/24 serum samples of infected individuals and in none of the samples from healthy individuals (FIG. 20). The results for the HIV type 1 infected individuals were consistent with those obtained from a commercial kit that is regularly used in hospitals for detection of HIV type 1. These results clearly demonstrate the utility of ZEPHYRIN LP56-41 in term of sensitivity and specificity compared to the ZEPHYRIN41.

### Example 21

### Microarray Application for Antibody-Antigen Interactions

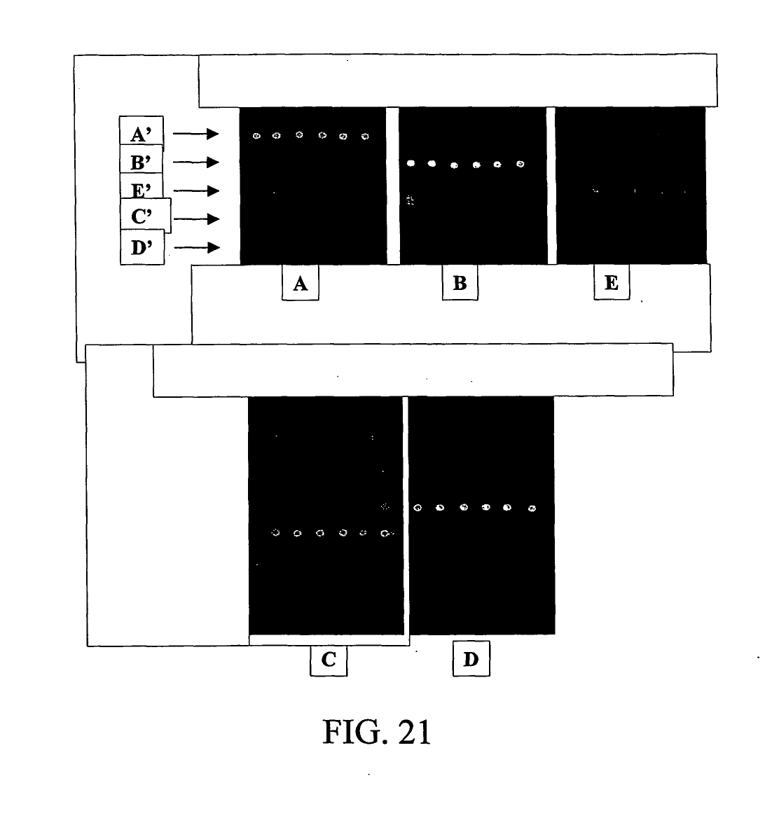

SEQ ID NO:4 was fused to a ZZ domain (two identical domains of Protein A molecule) to obtain a fusion protein, also termed ZEPHYRIN-ZZ, which was used to fabricate the antibody microarray. Four samples of ZEPHYRIN-ZZ (100 μg/ml) were pre-incubated with four FC-IgG rabbit antibodies directed against the following ion-channels peptides: HCN2, P2X1, P2X2 and GABA (Alomone Labs., Jerusalem, Israel) in a molar ratio of 1:1 and a final volume of 10 μl. After 30 min incubation at room temperature the four separate constructs of ZEPHYRIN-ZZ-antibodies: ZEPHYRIN-ZZ-anti-HCN2 (FIG. 21A′), ZEPHYRIN-ZZ-anti-P2X1, FIG. 21B′; ZEPHYRIN-ZZ-anti-P2X2, FIG. 21C′; and ZEPHYRIN-ZZ-anti-GABA, FIG. 21D′) and a biotinylated SEQ ID NO:4 (positive control, FIG. 21E′) were fabricated on cellulose coated glass slides. The slides were blocked with 0.5% BSA/PBS for 20 min and incubated with each of the four Cy-3 labeled ion-channels peptides (2 μg/ml; FIG. 21A-D) and Cy5-labeled Avidin (0.5 μg/ml; FIG. 21E) for 1 hr. A specific fluorescence signals was observed for each of the four fabricated antibodies using the Cy-labeled antigens (FIG. 21). Signal intensities were different from one antibody to the other suggesting different affinities of the antibodies for their cognate antigens. No cross-reactivity was observed for the tested antibodies. This sample establishes indirect and oriented immobilization of antibodies to a slide surface through ZEPPHYRIN-ZZ molecules.

### Example 22

### A Comparison of the Microarrays Based on the Teaching of the Present Invention with Current Commercial Microarray Slides

The performance of the microarrays of the present invention was compared with the performance of commercially available microarrays. For these purpose the following commercial microarray slides were utilized: Nunc 1, Nunc 2, Nunc 3 (Nalge Nunc International) and SMB (Scandinavian Micro Biodevices A/S, Denmark). The performance of these commercial slides was compared to that of homemade nitrocellulose (NC1) slides cellulose-coated (RC) slides in the context of the microarrays of the present invention. Four commercial anti ion-channel peptides antibodies were used: rabbit anti HCN2, rabbit anti P2X1, rabbit anti P2X2 and rabbit anti GABA (Alomone Labs., Jerusalem, Israel); and three additional antibodies: rabbit anti chicken FC antibody (Jackson ImmunoResearch Labs.), a home made rabbit anti-GST and a home-made N-terminal single chain (sc) antibody fused to SEQ ID NO:4 directed against streptavidin, also termed hereinafter scFv-ZEPHYRIN.

As described above, ZEPHYRIN-ZZ (100 μg/ml) was pre-incubated with the six rabbit antibodies in a molar ratio of 1:1 and a final volume of 10 μl for 30 min at room temperature resulting with constructs of ZEPHYRIN-ZZ-antibodies. These constructs and the scFv-ZEPHYRIN were fabricated on cellulose coated glass slides (RC). In each ZEPHYRIN-ZZ-antibody solution, the antibody concentration was about 30 μg/ml. Fabrication on the cellulose comprising slides (RC) was achieved using an automatic spotter and a volume of about 2 nanoliters per spot.

Antibodies, which were not conjugated to ZEPHYRIN-ZZ, were fabricated on the four commercial slides (according to the manufacturer instructions) as well as on a homemade nitrocellulose slide (NC1) using a large range of antibody concentrations, i.e. 10, 30, 100, 300 and 1200 μg/ml. Those antibody solutions included very high antibody concentrations, the order of 0.1-1 mg/ml, in order to assist binding to the commercial slides.

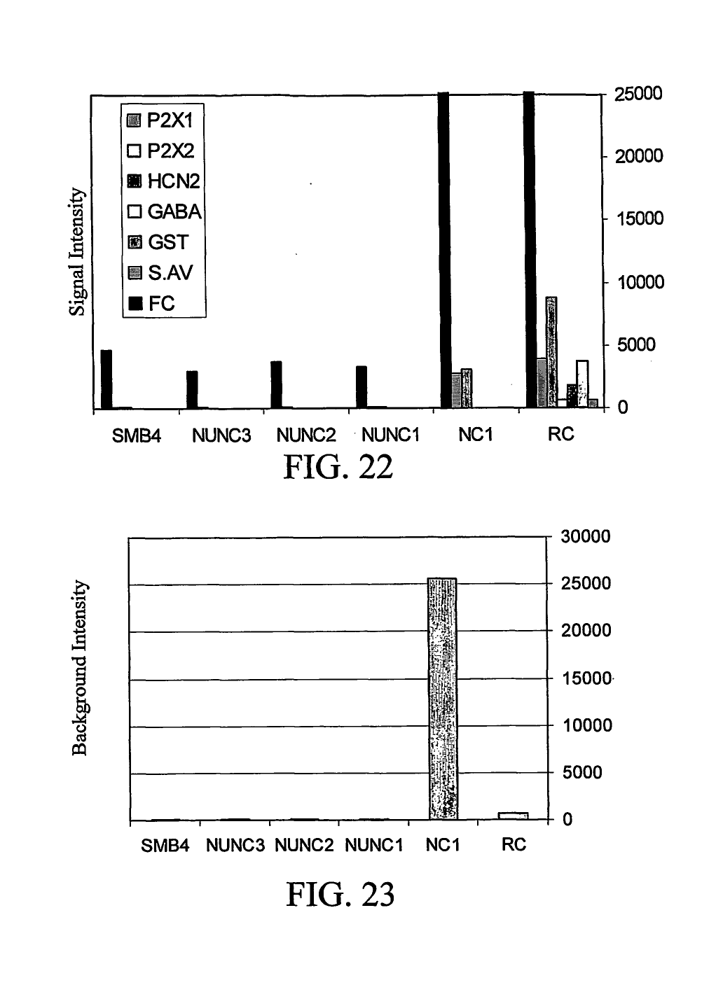

Slides were blocked with 2% BSA/PBS for 60 min following incubation with a mixture of specific Cy-3 labeled antigen (about 2 μg/ml at most, and no less than 0.1 μg/ml). The resulting signal intensities, background signals and a signal-to-noise ratio for the various slides and antigens are shown in FIGS. 22, 23 and 24, respectively. The results clearly indicate the advantage of the antibody microarrays of the present invention over the other slides.

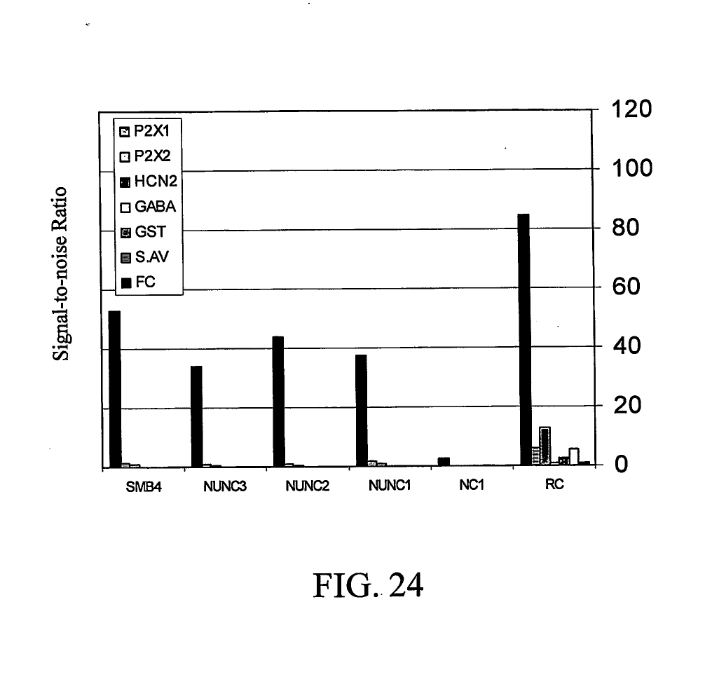

The results further indicate that signal intensity and specificity is enhanced using cellulose-coated slides, particularly the cellulose slides (RC). Signal intensities using slides comprising cellulose or nitrocellulose (NC1 and RC) was higher than signal intensities obtained with the other slides even at the lowest antibody concentrations (about 30 μg/ml) that were used to fabricate the cellulose-coated slide (FIG. 22). Furthermore, Specific signals, for all seven antibodies, were recorded only on the cellulose-coated slides (FIGS. 22 and 24). This observation further indicates that utilizing the microarrays of the present invention fabricated on cellulose-coated slides (CR) produces less background noise than antibody microarrays fabricated on nitrocellulose-coated slides (NR1) or other commercial slides (FIG. 23). FIG. 24 presents the signal-to-noise ratios (SNRs) of the various microarrays. This figure indicates that the microarrays of the present invention provides a better SNR than the SNR obtained by using various other commercial slides. The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention. Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

1-81. (canceled)

82. A library comprising a plurality of chimeric proteins wherein each chimeric protein comprises a cellulose binding region and at least one exogenous moiety introduced therein, and wherein the cellulose binding region is devoid of cellulolytic activity.

83. The library of claim 82, wherein the cellulose binding region is derived from a protein other than a member of the polysaccharidase family.

84. The library of claim 83, wherein the cellulose binding region is derived from the non-cellulolytic cellulosomal scaffolding Protein A subunit of Clostridium thermocellum.

85. The library of claim 83, wherein the cellulose binding region is selected from the group consisting of:
a) a cellulose binding region comprising an amino acid sequence having at least 80% homology to SEQ ID NO:4, and
b) a cellulose binding region comprising an amino acid sequence having at least 80% homology to SEQ ID NO:4 further comprising at least one additional amino acid sequence having at least 80% homology to any one of the sequences selected from the group consisting of: SEQ ID NO:5 and SEQ ID NO:6.
c) a cellulose binding region encoded by a polynucleotide sequence comprising a nucleotide sequence having at least 80% homology to SEQ ID NO:1, and
d) a cellulose binding region encoded by a polynucleotide sequence comprising a nucleotide sequence having at least 80% homology to SEQ ID NO:1, wherein the polynucleotide sequence further comprising at least one additional polynucleotide sequence having at least 80% homology to the any one of the nucleotide sequences selected from the group consisting of: SEQ ID NO:2 and SEQ ID NO:3.

86. The library of claim 82, wherein the at least one exogenous moiety is a biologically active moiety selected from the group consisting of: peptides, polypeptides, antigenic epitopes, polynucleotides, hormones, carbohydrates, lipids, phospholipids, biotinylated probes, enzymes, antibodies and fragments thereof.

87. The library of claim 86, wherein the biologically active moiety is a peptide.

88. The library of claim 87, wherein the peptide is 5 to 50 amino acids in length.

89. The library of claim 86, wherein the at least one exogenous biologically active moiety is introduced into the cellulose binding region at a predetermined location other than the C-terminus or the N-terminus of said cellulose binding region.

90. The library of claim 86, wherein the at least one exogenous biologically active moiety is fused to the cellulose binding region at the C-terminus or the N-terminus of said cellulose binding region.

91. The library of claim 86, wherein the at least one exogenous biologically active moiety is covalently linked to the cellulose binding region.

92. The library of claim 82, wherein each chimeric protein comprises a detectable label, the amount of the detectable label is indicative of the amount of chimeric protein.

93. A library comprising a plurality of polynucleotides, each polynucleotide is capable of encoding a chimeric protein comprising a cellulose binding region and at least one exogenous moiety introduced therein, and wherein the cellulose binding region is devoid of cellulolytic activity.

94. The library of claim 93, wherein the cellulose binding region is derived from a protein other than a member of the polysaccharidase family.

95. The library of claim 93, wherein the cellulose binding region is derived from the non-cellulolytic cellulosomal scaffolding Protein A subunit of Clostridium thermocellum.

96. The library of claim 93, wherein the polynucleotide is selected from the group consisting of:
a) a polynucleotide comprising a first nucleotide sequence capable of encoding the cellulose binding region having at least 80% homology to SEQ ID NO:4, and
b) a polynucleotide comprising a first nucleotide sequence capable of encoding the cellulose binding region having at least 80% homology to SEQ ID NO:4, wherein the first nucleotide sequence further encodes at least one additional amino acid sequence having at least 80% homology to any one of the sequences selected from the group consisting of: SEQ ID NO:5 and SEQ ID NO:6.
c) a polynucleotide comprising a first nucleotide sequence having at least 80% homology to SEQ ID NO:1, and
d) a polynucleotide comprising a first nucleotide sequence having at least 80% homology to SEQ ID NO:1, wherein the first nucleotide sequence further comprises at least one additional nucleotide sequence having at least 80% homology to the any one of the nucleotide sequences selected from the group consisting of: SEQ ID NO:2 and SEQ ID NO:3.

97. The library of claim 96, wherein the polynucleotide comprising a second nucleotide sequence encoding at least one exogenous biologically active moiety.

98. The library of claim 97, wherein the second nucleotide sequence is operably linked to the first nucleotide sequence such that the polynucleotide encodes a chimeric protein comprising at least one exogenous biologically active moiety fused to the cellulose binding region at the C-terminus or the N-terminus of said cellulose binding region.

99. The library of claim 97, wherein the second nucleotide sequence is operably linked to the first nucleotide sequence such that the polynucleotide encodes a chimeric protein comprising at least one exogenous biologically active moiety introduced into the cellulose binding region at a predetermined location other than the C-terminus or the N-terminus of said cellulose binding region.

100. The library of claim 97, wherein the at least one biologically active moiety is selected from the group consisting of: peptides, polypeptides, enzymes, antibodies and fragments thereof.

101. The library of claim 100, wherein the at least one biologically active moiety is a peptide of 5 to 50 amino acids in length.

102. A method for screening biologically active moieties, comprising:
(a) providing a plurality of discrete compartments, each compartment comprising a chimeric protein, the chimeric protein comprising a cellulose binding region devoid of cellulolytic activity and at least one exogenous biologically active moiety; and
(b) bringing into contact one or more aliquots of a sample with the content of each discrete compartment thereby bringing into contact said chimeric protein in each discrete compartment with the sample;
(c) printing one or more aliquots of the content of each discrete compartment onto at least one discrete location on a surface of a solid support, the surface comprising a cellulose polymer, thereby immobilizing the chimeric proteins within each discrete compartment onto said surface; and,
(d) detecting binding interactions between said sample and said chimeric protein.

103. The method of claim 102, wherein the at least one exogenous biologically active moiety is selected from the group consisting of: peptides and polypeptides, antigenic epitopes, polynucleotides, hormones, carbohydrates, lipids, phospholipids, biotinylated probes, enzymes, antibodies and fragments thereof.

104. The method of claim 103, wherein the biologically active moiety is a peptide of 5 to 50 amino acids in length.

105. The method of claim 103, wherein the at least one biologically active moiety is an exogenous peptide, the exogenous peptide is introduced into the cellulose binding region at a predetermined location other than the C-terminus or the N-terminus of said cellulose binding region.

106. The method of claim 103, wherein the at least one biologically active moiety is an exogenous peptide, the exogenous peptide is fused to the cellulose binding region at the C-terminus or the N-terminus of said cellulose binding region.

107. The method of claim 103, wherein at least one biologically active moiety is covalently linked to the cellulose binding region.

108. The method of claim 102, wherein the cellulose binding region is derived from a protein other than a member of the polysaccharidase family.

109. The method of claim 102, wherein the cellulose binding region is derived from the non-cellulolytic cellulosomal scaffolding Protein A subunit of Clostridium thermocellum.

110. The method of claim 102, wherein the cellulose binding region is selected from the group consisting of:
a. a cellulose binding region comprising an amino acid sequence having at least 80% homology to SEQ ID NO:4, and
b. a cellulose binding region comprising an amino acid sequence having at least 80% homology to SEQ ID NO:4, wherein the cellulose binding region further comprising at least one additional amino acid sequence having at least 80% homology to any one of the sequences selected from the group consisting of: SEQ ID NO:5 and SEQ ID NO:6.
c. a cellulose binding region encoded by a polynucleotide sequence comprising a nucleotide sequence having at least 80% homology to SEQ ID NO:1, and
d. a cellulose binding region encoded by a polynucleotide sequence comprising a nucleotide sequence having at least 80% homology to SEQ ID NO:1, wherein the polynucleotide sequence further comprising at least one additional polynucleotide sequence having at least 80% homology to the any one of the nucleotide sequences selected from the group consisting of: SEQ ID NO:2 and SEQ ID NO:3.

111. The method of claim 102, wherein each chimeric protein comprising a detectable label, the amount of the detectable label is indicative of the amount of chimeric protein.

112. The method of claim 102, wherein each chimeric protein comprises at least two biologically active moieties, the at least two biologically active moieties are the same or different from one another.

113. The method of claim 102, wherein step (b) comprising: incubating one or more aliquots of a sample with the content of each discrete compartment for at least 5 minutes, thereby bringing into contact said chimeric protein in each discrete compartment with the sample.

114. The method of claim 102, wherein the sample is provided in a solution.

115. The method of claim 102, wherein the sample is provided in a non-immobilized dry form and is suspended to obtain a corresponding sample solution prior to, or during, step (b).

116. The method of claim 102, wherein the sample is provided in a form selected from: an immobilized form or present on a solid structure.

117. The method of claim 116, wherein prior to step (c), the content of each discrete compartment together with said sample, obtained in step (b), are treated to remove unbound chimeric protein and further to release from immobilization bound chimeric proteins.

118. The method of claim 102, wherein the chimeric proteins are provided in a dry form are suspended to obtain a corresponding solution prior to, or during, step (b) of the method.

119. A kit comprising:
(a) a plurality of discrete compartments, each compartment comprising a chimeric protein, the chimeric protein comprising a cellulose binding region devoid of cellulolytic activity and at least one exogenous biologically active moiety; and, optionally,
(b) a solid support having a surface, the surface comprising a substrate capable of binding the cellulose binding region.

120. The kit of claim 119, wherein the cellulose binding region is derived from a protein other than a member of the polysaccharidase family.

121. The kit of claim 119, wherein the cellulose binding region is derived from the non-cellulolytic cellulosomal scaffolding Protein A subunit of Clostridium thermocellum.

122. The kit of claim 119, wherein the cellulose binding region is selected from the group consisting of
a. a cellulose binding region comprising an amino acid sequence having at least 80% homology to SEQ ID NO:4, and
b. a cellulose binding region comprising an amino acid sequence having at least 80% homology to SEQ ID NO:4, wherein the cellulose binding region further comprising at least one additional amino acid sequence having at least 80% homology to any one of the sequences selected from the group consisting of: SEQ ID NO:5 and SEQ ID NO:6.
c. a cellulose binding region encoded by a polynucleotide sequence comprising a nucleotide sequence having at least 80% homology to SEQ ID NO:1, and
d. a cellulose binding region encoded by a polynucleotide sequence comprising a nucleotide sequence having at least 80% homology to SEQ ID NO:1, wherein the polynucleotide sequence further comprising at least one additional polynucleotide sequence having at least 80% homology to the any one of the nucleotide sequences selected from the group consisting of: SEQ ID NO:2 and SEQ ID NO:3.

123. The kit of claim 119, wherein the at least one biologically active moiety is selected from the group consisting of: peptides, polypeptides, antigenic epitopes, polynucleotides, hormones, carbohydrates, lipids, phospholipids, biotinylated probes, enzymes, antibodies and fragments thereof.

124. The kit of claim 123, wherein the biologically active moiety is a peptide of 5 to 50 amino acids in length.

125. The kit of claim 119, wherein the at least one exogenous biologically active moiety is introduced into the cellulose binding region at a predetermined location other than the C-terminus or the N-terminus of said cellulose binding region.

126. The kit of claim 119, wherein the at least one exogenous biologically active moiety is fused to the cellulose binding region at the C-terminus or the N-terminus of said cellulose binding region.

127. The kit of claim 119, wherein the at least one exogenous biologically active moiety is covalently linked to the cellulose binding region.

128. The kit of claim 119, wherein the surface of the solid support comprises a substance selected from the group consisting of: cellulose homopolymers, cellulose heteropolymers, cellulose acetate, microcrystalline cellulose, lignin, starch, xylane.

129. The kit of claim 119, wherein the solid support comprises a material selected from the group consisting of: glass, ceramics, metal and plastics.


SEQUENCE LISTING (28 sequences)

SEQ ID NO: 1 - DNA, 501 bp, Clostridium thermocellum
gcaaatacaccggtatcaggcaatttgaaggttgaattctacaacagcaatccttcagatactactaactcaatcaatcctcagttcaaggttactaataccggaagcagtgcaattgatttgtccaaactcacattgagatattattatacagtagacggacagaaagatcagaccttctggtgtgaccatgctgcaataatcggcagtaacggcagctacaacggaattacttcaaatgtaaaaggaacatttgtaaaaatgagttcctcaacaaataacgcagacacctaccttgaaataagctttacaggcggaactcttgaaccgggtgcacatgttcagatacaaggtagatttgcaaagaatgactggagtaactatacacagtcaaatgactactcattcaagtctgcttcacagtttgttgaatgggatcaggtaacagcatacttgaacggtgttcttgtatggggtaaagaacccggtggcagtgtagta

SEQ ID NO: 2 - DNA, 114 bp, Clostridium thermocellum
aatgcaacaccgaccaagggagcaacaccaacaaatacagctacgccgacaaaatcagctacggctacgcccaccaggccatcggtaccgacaaacacaccgacaaacacaccg

SEQ ID NO: 3 - DNA, 102 bp, Clostridium thermocellum
ccatcaacacagcctgtaacaacaccacctgcaacaacaaaaccacctgcaacaacaaaaccacctgcaacaacaataccgccgtcagatgatccgaatgca

SEQ ID NO: 4 - protein, 167 aa, Artificial Sequence
  Recombinant protein
ANTPVSGNLKVEFYNSNPSDTTNSINPQFKVTNTGSSAIDLSKLTLRYYYTVDGQKDQTFWCDHAAIIGSNGSYNGITSNVKGTFVKMSSSTNNADTYLEISFTGGTLEPGAHVQIQGRFAKNDWSNYTQSNDYSFKSASQFVEWDQVTAYLNGVLVWGKEPGGSVV

SEQ ID NO: 5 - protein, 38 aa, Artificial Sequence
  Recombinant protein
NATPTKGATPTNTATPTKSATATPTRPSVPTNTPTNTP

SEQ ID NO: 6 - protein, 34 aa, Artificial Sequence
  Recombinant protein
PSTQPVTTPPATTKPPATTKPPATTIPPSDDPNA

SEQ ID NO: 7 - protein, 12 aa, Human immunodeficiency virus type 1 - gp41 epitope
LGIWGCSGKLIC

SEQ ID NO: 8 - DNA, 37 bp, Artificial Sequence
  pcr primer I
gagatatatcatgagcgctaatacaccggtatcaggc

SEQ ID NO: 9 - DNA, 63 bp, Artificial Sequence
  pcr primer II
tagcagggatccttavnnvnnvnnvnnvnnvnnvnnvnnactgcctacaggctgtgttgatgg

SEQ ID NO: 10 - protein, 8 aa, Homo sapiens
EILDVPST

SEQ ID NO: 11 - DNA, 29 bp, Artificial Sequence
  pcr primer III
ccgcaccatggcaaatacaccggtattca

SEQ ID NO: 12 - DNA, 31 bp, Artificial Sequence
  pcr primer IV
tcgcggatccttatactacactgccaccggg

SEQ ID NO: 13 - DNA, 42 bp, Artificial Sequence
  pcr primer V
gcccgttgaaaccgtgccggtcacttttacaaatgttccttt

SEQ ID NO: 14 - DNA, 41 bp, Artificial Sequence
  pcr primer VI
gtgaccggcacggtttcaacgggcgacacctaccttgaaat

SEQ ID NO: 15 - protein, 8 aa, Artificial Sequence
  mutation in loop 56 of Clostridium Thermocellum
VTGTVSTG

SEQ ID NO: 16 - protein, 8 aa, Clostridium thermocellum
MSSSTNNA

SEQ ID NO: 17 - protein, 8 aa, Clostridium thermocellum
MSSSTNNA

SEQ ID NO: 18 - protein, 7 aa, Clostridium thermocellum
LRRASLG

SEQ ID NO: 19 - protein, 8 aa, Human immunodeficiency virus type 1
GCSGKLIC

SEQ ID NO: 20 - protein, 10 aa, Homo sapiens
GSSWSADLDK

SEQ ID NO: 21 - DNA, 27 bp, Artificial Sequence
  PCR primer
tggaccatggcaaatacaccggtatca

SEQ ID NO: 22 - DNA, 35 bp, Artificial Sequence
  PCR primer
tagcagccggatccttatactacactgccaccggg

SEQ ID NO: 23 - DNA, 39 bp, Artificial Sequence
  PCR primer
ttgcgtcgcgcatctttgggcgacacctaccttgaaata

SEQ ID NO: 24 - DNA, 39 bp, Artificial Sequence
  PCR primer
gcccaaagatgcgcgacgcaacatttttacaaatgttcc

SEQ ID NO: 25 - DNA, 27 bp, Artificial Sequence
  PCR primer
tggaccatggcaaatacaccggtatca

SEQ ID NO: 26 - DNA, 35 bp, Artificial Sequence; identical to SEQ ID NO: 22
  PCR primer

SEQ ID NO: 27 - DNA, 42 bp, Artificial Sequence
  PCR primer
ggctgcagcggcaaattgatctgcgacacctaccttgaaata

SEQ ID NO: 28 - DNA, 42 bp, Artificial Sequene
  PCR primer
gcagatcaatttgccgctgcagccttttacaaatgttccttt